(19) United States
(12) Patent Application Publication
(10) Pub. No.: US 2026/0319915 A1
(43) Pub. Date: Oct. 15, 2026

(54) SYSTEMS AND METHODS FOR PROCESS MONITORING AND OPTIMIZATION USING ARTIFICIAL INTELLIGENCE AND DISTRIBUTED LEDGER TECHNOLOGY

(71) Applicant: BANK OF AMERICA CORPORATION, Charlotte, NC (US)

(72) Inventors: Pradeep Bhupathi, Hyderabad (IN); Raja Venkatesh Gottumukkala, Chennai (IN); Jayadev Pradhan, Plano, TX (US); Venugopala Rao Randhi, Hyderabad (IN); Chhaya Sharma, Hyderabad, Telangana (IN)

(73) Assignee: BANK OF AMERICA CORPORATION, Charlotte, NC (US)

(21) Appl. No.: 19/179,768

(22) Filed: Apr. 15, 2025

(51) Int. Cl. G06F 11/3604; G06F 11/3668

(52) U.S. Cl. CPC G06F 11/3608; G06F 11/3684; G06F 11/3688

(57) ABSTRACT

Systems, computer program products, and methods are described herein for process monitoring and optimization using artificial intelligence and distributed ledger technology. The present disclosure is configured to scan a system framework of an entity, which comprises identifying elements of the system framework and dependencies of each element and analyzing, each of the one or more elements and the dependencies using an artificial intelligence (AI) model. The disclosure is further configured to determine, using the AI model whether each element requires modification and how the element needs to be modified. The disclosure is further configured to, using the AI model: generate code to modify the elements requiring modification; generate and execute test cases to test the code, which comprises implementing the code within one or more isolated portions of the system framework; determine whether the code is ready for implementation; and deploy the code.

### TECHNOLOGICAL FIELD

The present disclosure is related generally to process monitoring and optimization using artificial intelligence and distributed ledger technology and, more specifically, including artificial intelligence (AI), including machine learning and generative AI, to optimize system processes by generating, testing and deploying code upon detecting modification requirements to the existing system.

### BACKGROUND

An entity may periodically require making changes to its systems. However, various processes within an entity's systems may depend on one another, such that one change may have a complex ripple effect. Ensuring that business operations run seamlessly when changes to the system need to be made may become a difficult and cumbersome process that requires multiple changes to be made to address a single requirement.

Applicant has identified a number of deficiencies and problems associated with system process monitoring and optimization, as described in the paragraph above. Therefore, a need exists to develop systems, computerized methods, computer program products and the like that provides for process monitoring and optimization of system processes. Through applied effort, ingenuity, and innovation, many of these identified problems have been solved by developing solutions that are included in embodiments of the present disclosure, many examples of which are described in detail herein.

### BRIEF SUMMARY

The following a simplified summary of one or more embodiments of the disclosure in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present disclosure provide for systems, methods, computer program products and the like that provide for process monitoring and optimization using artificial intelligence and distributed ledger technology.

A system for process monitoring and optimization using artificial intelligence and distributed ledger technology defines first embodiments of the disclosure. The system comprises a memory device comprising a non-transitory computer-readable medium with computer-readable program code stored thereon and at least one processing device operatively coupled to the at least one memory device and at least one communication device. When executed, the computer-readable code is configured to cause the at least one processing device to scan a system framework of an entity, wherein scanning the system framework comprises identifying one or more elements of the system framework and dependencies of each of the one or more elements. The computer-readable code is further configured to cause the at least one processing device to analyze, each of the one or more elements and the dependencies using an artificial intelligence (AI) model, wherein the analyzing further comprises determining functionality and how each of the elements modifies the dependencies of the element; determine, using the AI model and for each of the one or more elements, that the element requires modification based on the analysis of the elements and the dependencies; and determine, using the AI model and for each of the one or more elements that require modification, one or more modifications for the element. The computer-readable code is further configured to cause the at least one processing device to generate, using the AI model and for each of the one or more elements that require modification, code to modify the element based on the determination of the one or more modification for the element; generate, using the AI model, and execute test cases to test the code, wherein generating and executing test cases comprises implementing the code within one or more isolated portions of the system framework; determine, using the AI model and based on executing the test cases, that the code is ready for implementation; and deploy the code upon determining that the code is ready for implementation.

In some embodiments of the disclosure, determining, for each of the one or more elements that require modification, that the element requires modification comprises: receiving internal rules and external rules; analyzing, using the AI model, the internal rules, the external rules, and the system framework, wherein the analysis comprises mapping one or more segments of the internal rules or one or more segments of the external rules to each of the one or more elements of the system framework; determining, using the AI model and based on the analysis, that the system framework requires modification to be in compliance with the internal rules and the external rules; and determining, using the AI model, based on the analysis and upon determination that the system framework requires modification, which of the one or more elements of the system framework require modification.

In some embodiments of the system determining, for each of the one or more elements that require modification, one or more modifications for the element comprises: identifying the elements that require modification; receiving internal rules and external rules; and analyzing, using the AI model, the internal rules, the external rules, and each of the elements that require modification, wherein the analysis comprises mapping one or more segments of the internal rules or one or more segments of the external rules to each of the elements that require modification. Determining one or more modifications for the element further comprises determining, using the AI model and for each of the elements that require modification and based on the analysis, a gap between the element and an associated segment of the internal rules or the external rules; and determining, using the AI model and for each of the elements that require modification and based on the gap, specific modifications to achieve compliance with the internal rules and the external rules.

In some embodiments of the disclosure, generating, for each of the one or more elements that require modification, code to modify the element based on the determination of the one or more modifications for the element may comprise: generating, using the AI model, multiple code suggestions based on the determination of how the element needs to be modified; transmitting, in a human-readable form, the multiple code suggestions to a user device of a user associated with the entity; requesting the user to approve one of the multiple code suggestions; receiving approval from the user for one of the multiple code suggestions; and generating, using the AI model, code based on the approved code suggestion. In some embodiments, transmitting the multiple code suggestions comprises transmitting summaries of the multiple code suggestions.

In some embodiments of the disclosure the following steps may occur simultaneously and in real time: scanning the system framework of the entity, wherein scanning the system framework comprises identifying one or more elements of the system framework and dependencies of each of the one or more elements; analyzing, each of the one or more elements and the dependencies using an artificial intelligence (AI) model, wherein the analyzing further comprises determining functionality and how each of the elements modifies the dependencies of the element; and determining, using the AI model, for each of the one or more elements, that the element requires modification based on the analysis of the elements and the dependencies.

In some embodiments of the disclosure, the computer-readable code is further configured to cause the at least one processing device to: receive as input one or more distributed ledger technologies, wherein each of the one or more distributed ledger technologies are associated with predefined conditions; receive approval from a user for the predefined conditions associated with each of the one or more distributed ledger technologies; and implement the one or more distributed ledger technologies upon receiving approval from the user, wherein an implemented distributed ledger technology is configured to approve processes based on the predefined conditions associated with the implemented distributed ledger technology. In further embodiments of the disclosure, the one or more distributed ledger technologies is used to approve at least one of the following processes: analyzing, each of the one or more elements and the dependencies using an artificial intelligence (AI) model, wherein the analyzing further comprises determining functionality and how each of the elements modifies the dependencies of the element; determining, using the AI model, for each of the one or more elements, that the element requires modification based on the analysis of the elements and the dependencies; or determining, using the AI model, for each of the one or more elements that require modification, one or more modifications for the element.

In some embodiments of the disclosure, determining, based on executing the test cases, that the code is ready for implementation comprises analyzing the system framework and analyzing each of the one or more elements and the dependencies to determine functionality and how each of the elements impacts the element's dependencies. In further embodiments, determining that the code is ready for implementation further comprises determining, using the AI model and based on the analyses, that the functionality of the elements and the functionality of the dependencies has not been negatively impacted by the test cases and determining, using the AI model and based on the analyses, that the test cases do not cause any negative impact to the system framework. In some embodiments, determining whether the code is ready for implementation may further comprise receiving internal rules and external rules; analyzing the internal rules and the external rules; determining, using the AI model, based on the analyses, that implementation of the code would ensure the system framework is in compliance with the internal rules and the external rules; and determining, using the AI model and upon determination that the functionality of the elements and the functionality of the dependencies has not been negatively impacted by the test cases, that the test cases do not cause any negative impact to the system framework and that implementation of the code would ensure the system framework is in compliance with the internal rules and the external rules, that the code is ready for implementation.

In some embodiments of the disclosure, the computer-readable code is further configured to implement an auto-recovery process, wherein the auto-recovery process comprises: saving one or more copies of the system framework; receiving an instruction from a user associated with the entity to restore a specified copy of the system framework, wherein the specified copy is one of the one or more copies; and restoring the specified copy of the system framework. In further embodiments of the disclosure, the one or more copies of the system framework are saved prior to execution of at least one of the following: generating, using the AI model and for each of the one or more elements that require modification, code to modify the element based on the determination of how the element needs to be modified; generating, using the AI model, and execute test cases to test the code, wherein generating and executing test cases comprises implementing the code within one or more isolated portions of the system framework; determining, using the AI model and based on the test cases, that the code is ready for implementation; or deploying the code upon determining that the code is ready for implementation.

In some embodiments of the disclosure, the computer-readable code is further configured to: determine when a user makes any change to the system framework; receive internal rules and external rules; analyze the change, the internal rules and the external rules; determine, based on the analysis, whether the changes are impacted by the internal rules or the external rules; and transmit, upon determining that the changes are impacted by the internal rules or the external rules, an alert to a user device of the user that the changes are impacted by the internal rules or the external rules.

In some embodiments of the disclosure, the AI model is trained by a user in a first instance and continuously retrained using data associated with each instance the AI model is used.

Similarly, and as a person of skill in the art will understand, each of the features, functions, and advantages provided herein with respect to the system disclosed herein above may additionally be provided with respect to a computer-implemented method and computer program product. Such embodiments are provided for exemplary purposes below and are not intended to be limited.

Thus, according to embodiments of the disclosure, which will be discussed in greater detail below, the present disclosure provides for process monitoring and optimization using artificial intelligence and distributed ledger technology that allows for the seamless and efficient modification of an entity's system framework. Specifically, the disclosure provides for scanning a system framework to identify the system framework's various elements and the dependencies of those elements and analyzing the elements and the dependencies to determine which elements require modification and how the elements that require modification need to be modified. The disclosure further provides for generating code to modify the elements that need to be modified, testing the code to determine if the code is ready for implementation and, if the code is ready for implementation, deploying the code within the system framework. In some embodiments, an artificial intelligence (AI) model is used for at least one of the processes provided for in the disclosure. In some embodiments of the disclosure, modifications may be required to achieve compliance with internal or external rules. As such, determining whether and how the elements and dependencies need to be modified may comprise receiving and analyzing internal and external rules and analyzing the elements and dependencies along with the internal and external rules to determine gaps between the elements and dependencies and the internal and external rules. In some embodiments, the disclosure provides for continuous, real time monitoring of the system framework and the rules to identify changes to either and determine compliance in real time. In some embodiments of the disclosure, generating code comprises generating multiple code suggestions and receiving approval from a user for one code suggestion to test and deploy. In some embodiments, the disclosure provides for implementing one or more distributed ledger technologies that are used to approve various steps that may occur in the embodiment of the disclosure. In some embodiments, the disclosure provides for implementing an auto-recovery process that saves copies of the system framework at various stages and restores a copy upon receiving an instruction from the user to do so. In some embodiments of the disclosure, the AI model is trained by a user in a first instance and continuously retrained using data associated with each instance the AI model is used.

The above summary is provided merely for purposes of summarizing some example embodiments to provide a basic understanding of some aspects of the present disclosure. The features, functions, and advantages that have been discussed may be achieved independently in various embodiments of the present disclosure or may be combined with yet other embodiments, further details of which can be seen with reference to the following description and drawings. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for process monitoring and optimization using artificial intelligence and distributed ledger technology, in accordance with an embodiment of the disclosure;

FIG. 2 illustrates an exemplary artificial intelligence (AI) subsystem architecture, in accordance with an embodiment of the disclosure;

FIGS. 3A-3B illustrate an exemplary distributed ledger technology (DLT) architecture, in accordance with an embodiment of the disclosure;

FIG. 4 illustrates a process flow for process monitoring and optimization using artificial intelligence and distributed ledger technology, in accordance with an embodiment of the disclosure;

FIG. 5 illustrates a process flow for determining whether each element of the system framework requires modification, in accordance with an embodiment of the disclosure;

FIG. 6 illustrates a process flow for determining how each element of the system framework needs to be modified, in accordance with an embodiment of the disclosure;

FIG. 7 illustrates a process flow for generating code to modify the elements of the system framework that require modification, in accordance with an embodiment of the disclosure;

FIG. 8 illustrates a process flow for implementing distributed ledger technologies, in accordance with an embodiment of the disclosure;

FIG. 9 illustrates a process flow for determining, based on executing the test cases, whether the code is ready for implementation, in accordance with an embodiment of the disclosure;

FIG. 10 illustrates a process flow for implementing an auto-recovery process, in accordance with an embodiment of the disclosure;

FIG. 11 illustrates a process flow for alerting a user upon determination that the user made a non-compliant change within the system framework, in accordance with an embodiment of the disclosure;

FIG. 12 illustrates a process flow for analyzing internal and external rules, mapping elements and generating and implementing code, in accordance with an embodiment of the disclosure;

FIG. 13 illustrates a process flow for analyzing internal and external rules, determining compliance, and generating insights, in accordance with an embodiment of the disclosure; and

FIG. 14 illustrates a process flow for suggesting, generating, testing, and implementing code, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As will be appreciated by one of skill in the art in view of this disclosure, the present disclosure may be embodied as a system, a method, a computer program product or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present disclosure may take the form of a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present disclosure may be written in an object oriented, scripted or unscripted programming language such as JAVA, PERL, SMALLTALK, C++, PYTHON or the like. However, the computer program code/computer-readable instructions for carrying out operations of the disclosure may also be written in conventional procedural programming languages, such as the “C” programming language or similar programming languages.

Embodiments of the present disclosure are described below with reference to flowchart illustrations and/or block diagrams of method or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the disclosure.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “satisfying the threshold” or “meeting the threshold” may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

According to embodiments of the disclosure, which will be described in more detail below, systems, methods and computer program products are disclosed that provide for process monitoring and optimization using artificial intelligence and distributed ledger technology. Specifically, the disclosure provides for generating, testing, and deploying code to implement changes within a system framework, where the changes may be changes required to be in compliance with internal or external rules.

In the current environment, an entity may be subject to various rules, regulations or laws that impose certain requirements on the entity's system framework. Additionally, the entity may have internal rules, policies and procedures that impact components of the system framework. When there is a change in such external or internal rules, the system framework may require modification as well. However, various components of the system framework may depend on various others, such that one change may have a ripple effect throughout the system framework. Implementing changes to stay in compliance with both external and internal rules may therefore be a complicated and cumbersome task that requires analyzing how each change impacts the various components of the system framework.

Therefore, the disclosure provides for, using artificial intelligence, monitoring external and internal rules to identify any changes to the rules that require modification within the system framework and automatically suggesting changes and generating, testing and deploying code to implement the changes. The disclosure provides for analyzing the system framework to identify each element of the system framework and the dependencies of elements to register how a change to one element may affect other elements so that each of those dependent elements may be modified accordingly as well. Further, the disclosure provides for using distributed ledger technologies for approving suggestions and changes to implement at various stages. The disclosure may also provide for monitoring the system framework to detect changes to the system framework and identifying whether any such changes would be affected by the internal or external rules. The disclosure may also provide for, essentially, continuously monitoring the system framework and the internal and external rules in real time to ensure the system framework's compliance with the internal and external rules at all times.

Accordingly, the present disclosure provides for scanning a system framework of an entity, wherein scanning the system framework comprises identifying one or more elements of the system framework and dependencies of each of the one or more elements and analyzing each of the one or more elements and the dependencies using an artificial intelligence (AI) model, wherein the analyzing further comprises determining functionality and how each of the elements modifies the dependencies of the element. The disclosure further provides for determining, using the AI model and for each of the one or more elements, that the element requires modification based on the analysis of the elements and the dependencies. Determining that the element requires modification may comprise receiving internal rules and external rules and analyzing, using the AI model, the internal rules, the external rules, and the system framework. The analysis may comprise mapping one or more segments of the internal rules or one or more segments of the external rules to each of the one or more elements of the system framework. Determining that the element requires modification may further comprise determining, using the AI model and based on the analysis, that the system framework requires modification to be in compliance with the internal rules and the external rules and upon determining that the system framework required modification, determining which of the one or more elements of the system framework require modification.

The disclosure may further provide for determining, using the AI model and for each of the one or more elements that require modification, one or more modifications for the element. Determining the one or more modifications for the element may comprise identifying the elements that require modification, receiving internal rules and external rules and analyzing, using the AI model, the internal rules, the external rules, and each of the elements that require modification. The analysis may comprise mapping one or more segments of the internal rules or one or more segments of the external rules to each of the elements that require modification. Determining the one or more modifications for the element may further comprise determining a gap between the element and an associated segment of the internal rules or the external rules and determining, based on the gap, specific modifications to achieve compliance with the internal rules and the external rules..

The disclosure further provides for generating, using the AI model and for each of the one or more elements that require modification, code to modify the element based on the determination of the one or more modifications for the element. Generating code may comprise generating, using the AI model, multiple code suggestions based on the determination of how the element needs to be modified and transmitting, in a human-readable form, the multiple code suggestions to a user device of a user associated with the entity. Transmitting the multiple code suggestions comprises transmitting summaries of the multiple code suggestions. Generating code may further comprise requesting the user to approve one of the multiple code suggestions, receiving approval from the user for one of the multiple code suggestions, and generating, using the AI model, code based on the approved code suggestion.

The disclosure provides for generating, using the AI model, and executing test cases to test the code, wherein generating and executing test cases comprises implementing the code within one or more isolated portions of the system framework, and determining, using the AI model and based on executing the test cases, that the code is ready for implementation. Determining that the code is ready for implementation may comprise analyzing the system framework and analyzing each of the one or more elements and the dependencies to determine functionality and how each of the elements impacts the element's dependencies. Determining that the code is ready for implementation further comprises determining, using the AI model and based on the analyses, that the functionality of the elements and the functionality of the dependencies has not been negatively impacted by the test cases and determining, using the AI model and based on the analyses, that the test cases do not cause any negative impact to the system framework. Determining that the code is ready for implementation further comprises receiving internal rules and external rules, analyzing the internal rules and the external rules and determining, using the AI model, based on the analyses, that implementation of the code would ensure the system framework is in compliance with the internal rules and the external rules. Determining that the code is ready for implementation comprises determining, using the AI model and upon determination that the functionality of the elements and the functionality of the dependencies has not been negatively impacted by the test cases, that the test cases do not cause any negative impact to the system framework and that implementation of the code would ensure the system framework is in compliance with the internal rules and the external rules, that the code is ready for implementation. The disclosure provides for, upon determining that the code is ready for implementation, deploying the code within the system framework.

The disclosure may also provide for the following steps to occur simultaneously and in real time: scanning the system framework of the entity, analyze, each of the one or more elements and the dependencies, and determining whether each of the one or more elements requires modification.

The disclosure may also provide for implementing distributed ledger technologies, wherein implementing distributed technologies comprises receive as input one or more distributed ledger technologies. Each of the one or more distributed ledger technologies is associated with predefined conditions. Implementing distributed ledger technologies further comprises receiving approval from a user for the predefined conditions associated with each of the one or more distributed ledger technologies and implementing the one or more distributed ledger technologies upon receiving approval from the user. An implemented distributed ledger technology is configured to approve processes based on the predefined conditions associated with the implemented distributed ledger technology. The disclosure provides for using the one or more implemented distributed ledger technologies to approve at least one of the following processes: analyzing, each of the one or more elements and the dependencies using an artificial intelligence (AI) model, wherein the analyzing further comprises determining functionality and how each of the elements modifies the dependencies of the element; determining, for each of the one or more elements, that the element requires modification based on the analysis of the elements and the dependencies; or determining, for each of the one or more elements that require modification, one or more modifications for the element.

The disclosure provides for implementing an auto-recovery process, wherein the auto-recovery process comprises saving one or more copies of the system framework. The disclosure may provide for saving the one or more copies of the system framework prior to execution of at least one of the following: generating code, generating and executing test cases to test the code, determining whether the code is ready for implementation, and deploying the code. The auto-recovery process further comprises receiving an instruction from a user associated with the entity to restore a specified copy of the system framework, wherein the specified copy is one of the one or more copies, and restoring the specified copy of the system framework.

The disclosure may further provide for alerting a user that a change made by the user is impacted by the internal rules or the external rules. Alerting the user comprises determining when a user makes any change to the system framework, receiving internal rules and external rules, and analyzing the internal rules and the external rules along with the change. Alerting the user further comprises determining, based on the analysis, whether the changes are impacted by the internal rules or the external rules and transmitting, upon determining that the changes are impacted by the internal rules or the external rules, an alter to a user device of the user that the changes are impacted by the internal rules or the external rules. The disclosure may further provide for the AI model being trained by a user in a first instance and continuously retrained using data associated with each instance the AI model is used.

What is more, the present disclosure provides a technical solution to a technical problem. As described herein, the technical problem includes the difficulty of implementing changes within a system framework due to the interdependence of the various elements of the system framework, such that making one change may require multiple other changes to ensure the continued functionality of the system framework. The technical solution presented herein allows for analyzing the system framework to identify the various elements of the system framework and their dependencies, including how the elements and their dependencies are impacted by each other, and suggesting, generating, testing, and implementing code to modify the elements that need to be modified along with all their dependencies to ensure a seamless implementation of changes within the system framework. In particular, such an automatic analysis of the system framework's elements and dependencies and suggesting, generating, testing and implanting code to modify the elements and the dependencies is an improvement over existing solutions for implementing required changes within a system framework, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

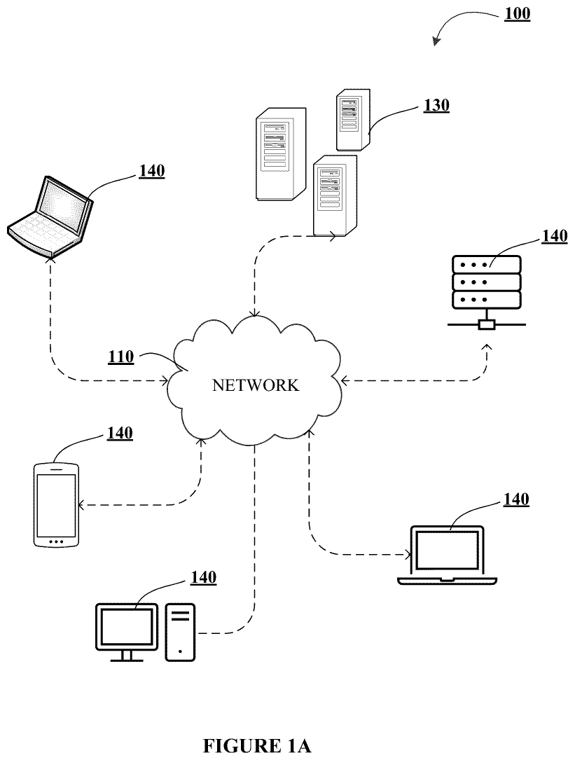

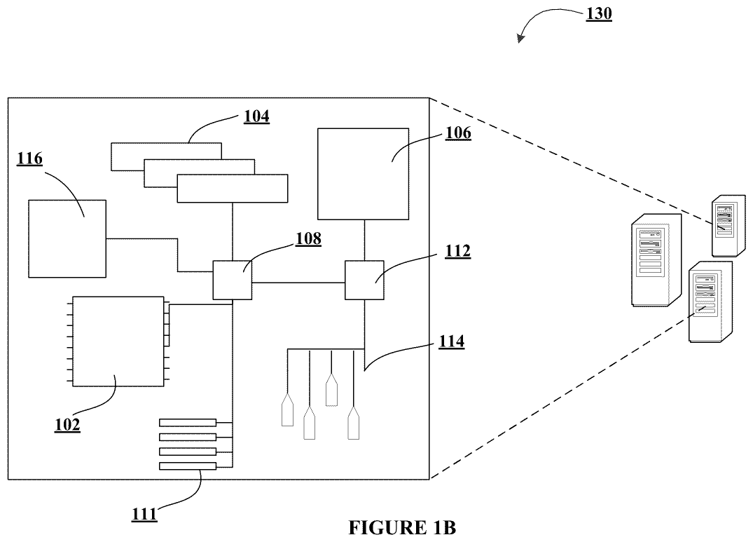

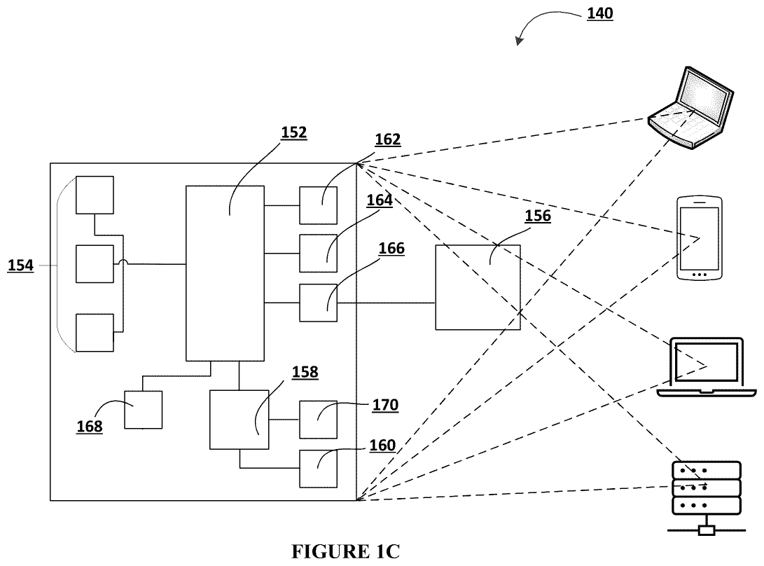

FIGS. 1A-1C illustrate technical components of an exemplary distributed computing environment for process monitoring and optimization using artificial intelligence and distributed ledger technology 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

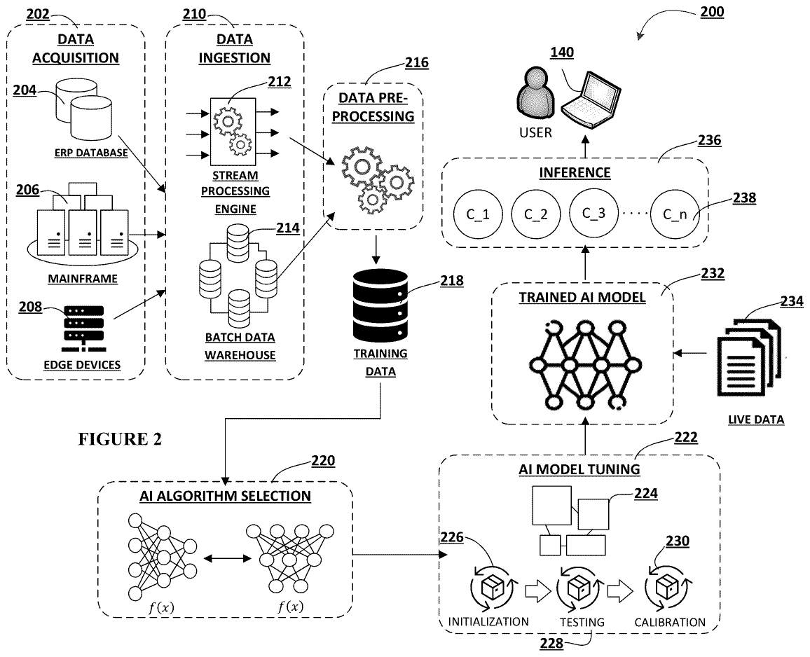

FIG. 2 illustrates an exemplary artificial intelligence (AI) subsystem architecture 200, in accordance with an embodiment of the disclosure. The artificial intelligence subsystem 200 may include a data acquisition engine 202, data ingestion engine 210, data pre-processing engine 216, AI model tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI model tuning engine 222 may be used to train an artificial intelligence model 224 using the training data 218 to make predictions or decisions without explicitly being programmed to do so. The artificial intelligence model 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the AI model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

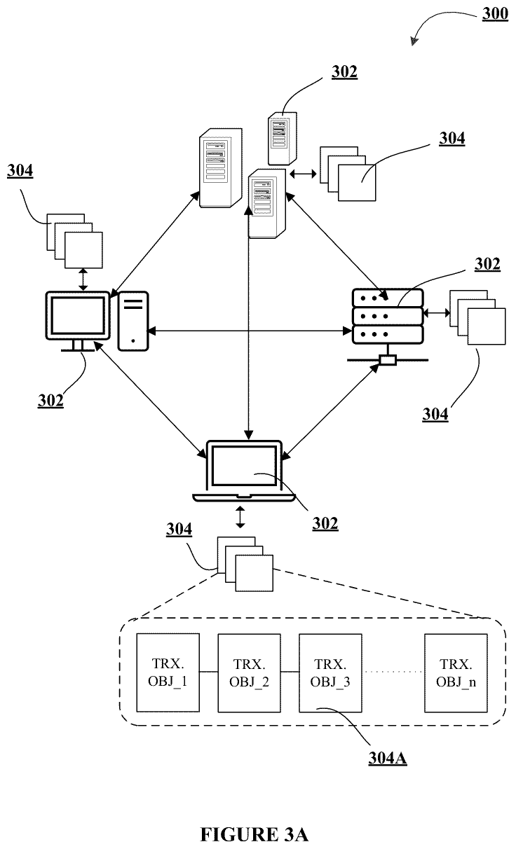

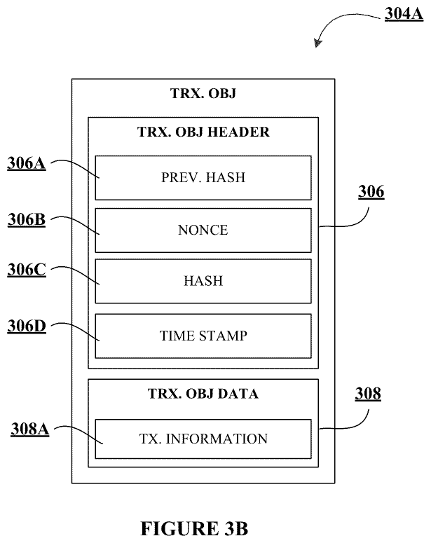

FIGS. 3A-3B illustrate an exemplary distributed ledger technology (DLT) architecture, in accordance with an embodiment of the disclosure. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and client device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B—a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

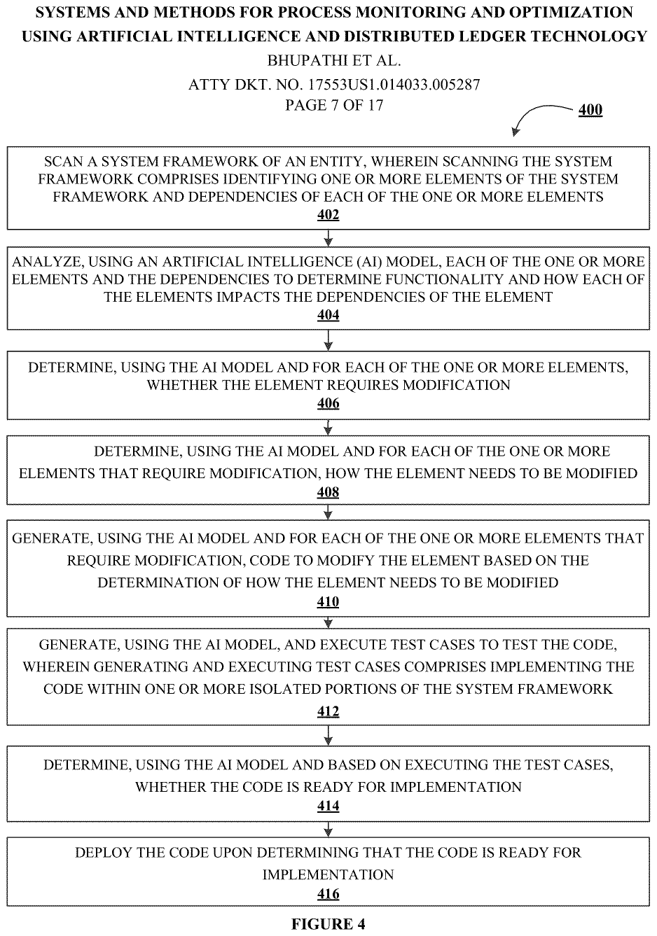

FIG. 4 illustrates a process flow 400 for process monitoring and optimization using artificial intelligence and distributed ledger technology, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIGS. 1A-1C) may perform the steps of process flow 400. Additionally, and in some embodiments, an AI model (like the AI model shown and described above with respect to FIG. 2) and/or a DLT ledger (like that shown and described above with respect to FIGS. 3A-3B) may perform one or more of the steps of process flow 400.

As shown in block 402, the process flow 400 may include the step of scanning a system framework, wherein scanning the system framework may comprise identifying one or more elements of the system framework and dependencies of each of the one or more elements. In some embodiments of the disclosure, the system framework is scanned using an artificial intelligence (AI) model. In some embodiments of the disclosure, the AI model may be used throughout the process depicted in FIG. 4. In some embodiments, the AI model may be trained in a first instance by a user. In some embodiments, the user may be a user associated with an entity associated with the system framework. In some embodiments, the user may be a distinct developer. In some embodiments, the AI model may be retrained using data associated with each instance the AI model is used. In some embodiments, the AI model is retrained automatically and continuously as the AI model is used. In some embodiments, a user may retrain the AI model.

In some embodiments, the system framework of an entity comprises one or more systems associated with the entity. In some embodiments, the system framework or the one or more systems may comprise one or more computing environments. In some embodiments, one or more of the systems and/or one or more of the computing environments may be connected or related to one another. In some embodiments, scanning the system framework may comprise reading and analyzing each of the various components of the system framework. Identifying the one or more elements of the system framework and the dependencies of the one or more elements comprises at least analyzing the system framework to distinguish between each of the various components of the system framework at various levels of the system framework and identifying each component as an element. For example, and in some embodiments, a component of the system framework may be an element of the system framework, but each subcomponent of that component may also be elements of the system framework. As such, in some embodiments, each od the dependencies of the elements are also elements of the system framework. In some embodiments, a dependency of an element is another element that is or the functionality of which is affected or impacted by the element. For example, if making any change to element A would in any way affect or impact the functionality of element B, element B is a dependency of element A. If making any change to element B has no effect or impact on element A or the functionality of element A, then, even though element B is a dependency of element A, element A is not a dependency of element B. If, however, making any change to element B also has an effect or impact on the functionality of element A, then element A and element B are both dependencies of each other. In some embodiments of the disclosure, this step of scanning the system framework, as described further with respect to block 402, occurs in real time and simultaneously with the steps of analyzing the elements and the dependencies, as described further with respect to block 404, and determining whether the element requires modification, as described further with respect to block 406.

As shown in block 404, the process flow 400 may include the step of analyzing the one or more elements and the dependencies. In some embodiments, an AI model is used to analyze the one or more elements and the dependencies. In some embodiments, analyzing the elements and the dependencies comprises determining functionality of each of the elements and the dependencies and determining how each of the elements modifies the dependencies of the element. In some embodiments, determining the functionality of an element or a dependency may comprise determining each element's role within the system framework, what the element does, and how important the element is to the functionality of the system framework or another element. For example, and in some embodiments, determining how important the element is may comprise determining whether the system or environment the element is a part of would function without the element. As another example, and in some embodiments, determining how important the element is may comprise determining whether changing element would materially impact the functionality of the dependencies of the element or of a system, environment or system framework as a whole. In some embodiments, determining how each of the elements modifies the dependencies of the element may comprise determining how each the elements and the dependencies interact. In some embodiments, how an element modifies a dependency is essentially how the dependency actually depends on the element, i.e., if the element does x, what does the dependency do. In some embodiments, determining how each of the elements modifies the dependencies may further comprise what change would be required for the dependencies to maintain functionality when a change is made to the element associated with the dependencies. In some embodiments of the disclosure, this step of analyzing the elements and the dependencies, as described further with respect to block 404, occurs in real time and simultaneously with the steps of scanning the system framework, as described further with respect to block 402, and determining whether the element requires modification, as described further with respect to block 406.

In some embodiments of the disclosure, the system provided for in the disclosure is configured to receive as input one or more distributed ledger technologies. In some embodiments, each of the one or more distributed ledger technologies are associated with predefined conditions. In some embodiments, the system receives approval from a user for the predefined conditions associated with each of the one or more distributed ledger technologies and upon receiving approval, the system implements the approved distributed ledger technologies. In some embodiments, an implemented distributed ledger technology is configured to approve processes based on the predefined conditions associated with the implemented distributed ledger technology. In some embodiments of the disclosure, this step of analyzing the elements and the dependencies to determine functionality and how each of the elements impacts the dependencies is approved using implemented distributed ledger technology. Essentially, the analysis of the elements and the dependencies may be received by the implemented distributed ledger technology, and if the analysis meets the predefined conditions, then the implemented distributed ledger technology may process and approve the analysis to be used in the following steps. In some embodiments of the disclosure, if the analysis is not approved, the AI model may analyze the elements and the dependencies again. In some embodiments, if the analysis is not approved, human intervention may be required. In some embodiments, the AI model may transmit an alert to a user that the analysis was not approved and may allow for the user to manually approve the analysis or provide instructions on how to proceed.

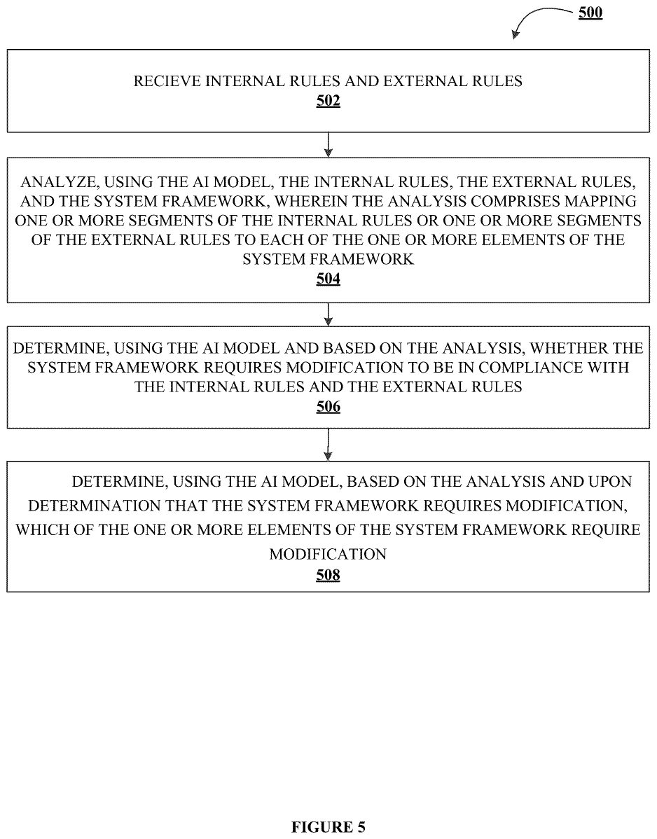

As shown in block 406, the process flow 400 may include the step of determining, for each of the one or more elements, that the element requires modification. In some embodiments of the disclosure, the AI model may be used to determine, for each of the one or more elements, that the element requires modification. In some embodiments of the disclosure, determining, for each of the one or more elements, that the element requires modification is based on the analysis of the elements and the dependencies. In some embodiments, determining that the element requires modification may comprise receiving an instruction that the element needs to be modified. In some embodiments, the instruction may be received from a user associated with the entity or system framework, from within the system framework, or from a secondary system. In some embodiments, determining that the element requires modification may comprise detecting whether there is an issue with the functionality of the element. In some embodiments, in cases where an element is a dependency, determining whether the element requires modification may comprise determining whether the element the dependency is associated with requires modification or has been modified. For example, if element B is a dependent of element A, determining whether element B requires modification may comprise determining whether element A requires modification or has already been modified. In some embodiments of the disclosure, and as further described with respect to FIG. 5 below, determining whether the elements require modification comprises receiving internal rules and external rules, analyzing the internal rules, the external rules and the system framework, determining whether the system framework requires modification, and determining which od the one or more elements of the system framework require modification. In some embodiments of the disclosure, this step of determining that the element requires modification, as described further with respect to block 406, occurs in real time and simultaneously with the steps of scanning the system framework, as described further with respect to block 402, and analyzing the elements and the dependencies, as described further with respect to block 404. In some embodiments of the disclosure, this step of determining whether the element requires modification, as described further with respect to block 406, occurs simultaneously with the step of determining how the element needs to be modified, as described further with respect to block 408. In some embodiments of the disclosure, this step of determining, for each of the one or more elements, that the element requires modification is approved using implemented distributed ledger technology. Essentially, each determination may be received by the implemented distributed ledger technology, and if the determination meets the predefined conditions, then the implemented distributed ledger technology may process and approve the determination to be used in the following steps. In some embodiments of the disclosure, if the determination is not approved, the AI model may make another determination. In some embodiments, if the determination is not approved, human intervention may be required. In some embodiments, the AI model may transmit an alert to a user that the determination was not approved and may allow for the user to manually approve the determination or provide instructions on how to proceed.

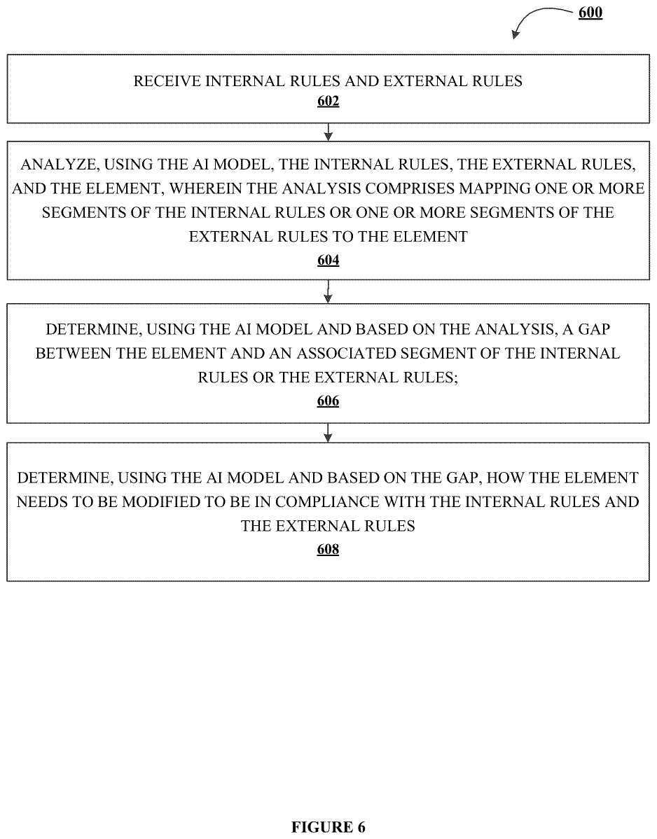

As shown in block 408, the process flow 400 may include the step of determining, for each of the one or more elements that require modification, one or more modifications for the element. In some embodiments, an AI model is used to determine the one or more modifications for the element. In some embodiments, determining the one or more modifications for the element may comprise receiving an instruction on how each element needs to be modified. In some embodiments, the instruction may be received from a user associated with the entity or system framework, from within the system framework, or from a secondary system. In some embodiments, determining the one or more modifications may comprise identifying what modification would maintain the element's functionality. In some embodiments, in the case of dependencies, determining how the dependency needs to be modified may comprise analyzing the modifications required by or made to the element associated with the dependency. For example, if element B is a dependency of element A, how element B needs to be changed may depend on how element A has been or needs to be changed. In some embodiments of the disclosure, and as described further with respect to FIG. 6, how the element needs to be modified may comprise receiving internal rules and external rules, analyzing, using the AI model, the internal rules, the external rules, and the element, wherein the analysis comprises mapping one or more segments of the internal rules or external rules to the element, determining a gap between the element and an associated segment of the rules, and determining the one or more modifications based on the gap. In some embodiments of the disclosure, determining how the element needs to be modified further comprises suggesting, using the AI model, specific modifications based on the determination of how the element needs to be modified. In some embodiments of the disclosure, this step of determining, for each of the one or more elements that require modification, one or more modifications for the element is approved using implemented distributed ledger technology. Essentially, each determination may be received by the implemented distributed ledger technology, and if the determination meets the predefined conditions, then the implemented distributed ledger technology may process and approve the determination to be used in the following steps. In some embodiments of the disclosure, if the determination is not approved, the AI model may make another determination. In some embodiments, if the determination is not approved, human intervention may be required. In some embodiments, the AI model may transmit an alert to a user that the determination was not approved and may allow for the user to manually approve the determination or provide instructions on how to proceed.

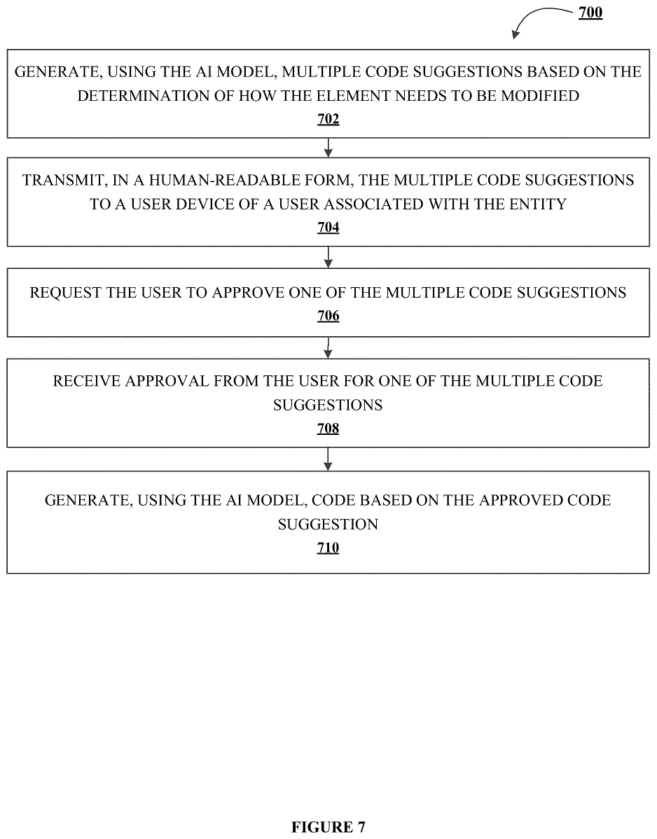

As shown in block 410, the process flow 400 may include the step of generating, for each of the one or more elements that require modification, code to modify the element based on the determination of how the element needs to be modified. In some embodiments of the disclosure, the AI model is used to generate code. In some embodiments, the AI model may be a generative AI and/or a machine learning model. In some embodiments of the invention, the elements of the system framework comprise code that can be added to, removed, modified, or replaced. In some embodiments of the disclosure, for each element of the system framework that requires modification, code is generated to modify the element such that the modified element would be in compliance with the internal rules and the external rules. Modifying the element may comprise adding code to the existing code of the element, modifying the existing code of the element, removing the existing code of the element (in whole or in part), or replacing the existing code of the element (in whole or in part). In some embodiments of the disclosure, the code may be generated upon receiving an instruction from a user, from the AI model, or from within the system framework to generate the code. In some embodiments, the instruction may include certain specifications for how the code should be generated or what the generated code should do. In some embodiments of the disclosure, and as further described with respect to FIG. 7 below, generating code may comprise generating multiple code suggestions, transmitting the suggestions to a user associated with the entity, requesting and receiving approval for one of the multiple suggestions and generating the code based on the approved suggestion. In some embodiments, transmitting multiple code suggestions may comprise transmitting summaries of the multiple code suggestions.

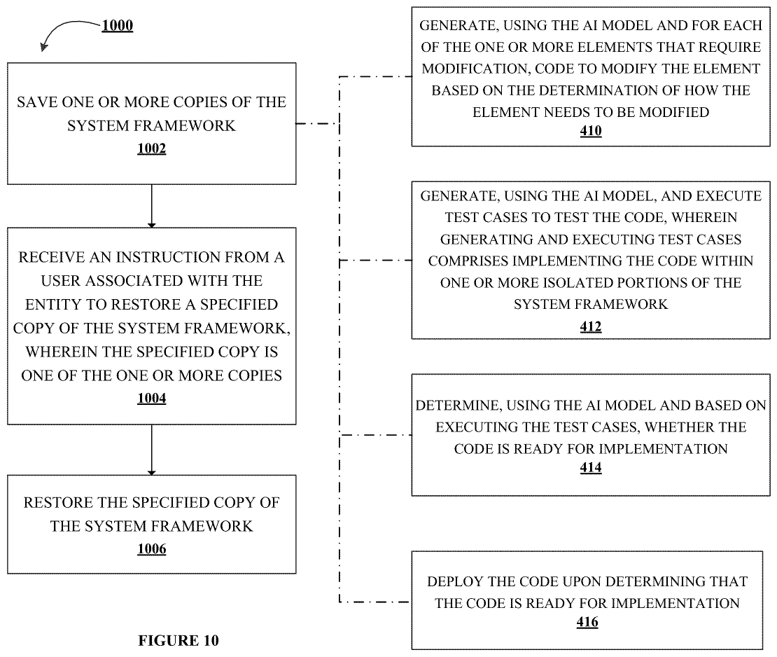

In some embodiments of the disclosure, one or more copies of the system framework may be saved prior to execution of this step of generating code to modify an element of the system framework. A saved copy may be used as part of an auto-recovery process, as further described below with respect to FIG. 10.

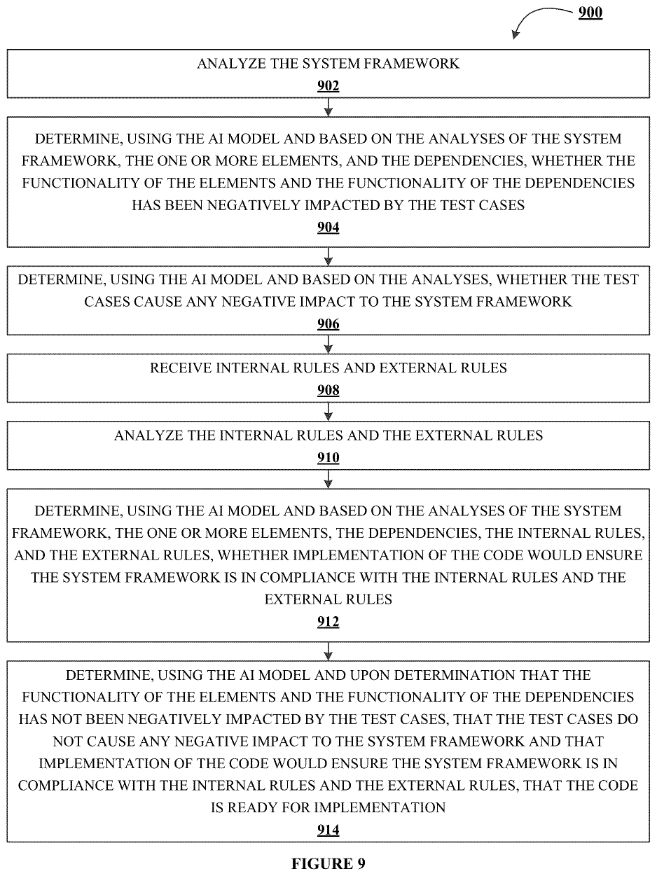

As shown in block 412, the process flow 400 may include the step of generating and executing test cases to test the code. In some embodiments of the disclosure, the AI model is used to generate and execute test cases. Once code has been generated to modify an element, a test case may be generated, wherein the test case is the modified version of the element. A test case may be generated such that the actual element of the system framework is not modified before testing as described in this paragraph describing block 412 and the paragraph below describing block 414. In some embodiments, generating and executing test cases comprises implementing the code within one or more isolated portions of the system framework. In some embodiments, the test case may be implemented within one or more isolated portions of the system framework to determine whether the modified element as represented by the test case would function as expected within the system framework. In some embodiments, the steps depicted in FIG. 4 may be an iterative process. In some embodiments, the AI model may determine when to repeat steps. In some embodiments, for example, the system framework may be analyzed after implementing the test case in a portion of the system framework to determine if prior analyses in this process were affected. For example, the analysis may reveal whether new dependencies were created as a result of the implementation of the test case or whether existing dependencies were affected. Upon determining such an effect, for example and in some embodiments, new code may be generated to deal with such changes. In some embodiments, essentially, if the AI model determines based on implementation of a test case that implementing the generated code would have various other effects on the system framework, the AI model may restart the process depicted in FIG. 4 with the test cases active as a starting point to determine if additional modifications are required and to generate code and generate and execute test cases based on those additional requirements. In some embodiments, the process may be repeated until multiple test cases are in place and AI model does not determine any additional modifications are required. In some embodiments, determining whether additional modifications are required may comprise determining whether code is ready for implementation, as described further below with respect to block 414 and FIG. 9.

A more detailed example of how the iterative process may work is as follows, in accordance with an embodiment of the disclosure. The system, as provided for in the disclosure, scans a system framework associated with the entity and identifies an element A of the system framework and an element B that is a dependency of element A. An AI model analyzes the elements and determines how each element functions and how each element relates to the other, including which aspect of element B depends on element A. The AI model may then determine that element B needs to be modified to comply with a change in an internal or external rule and determines what modification is required for element B to be in compliance with the rule. The AI model may then generate code that would modify element B for compliance with the rule and generate a separate modified version of element B as a test case. The AI model may, without actually changing element B, implement the test case, and then scan the system framework again to identify whether the elements and the dependencies remain the same and analyze the elements to determine functionality. For example, implementing the test case may have created a new element C, that is a dependency of element B. The AI model then determines for all elements, including element C, whether the elements require modification and how they need to be modified. If, for example, the AI model determines that, as a result of the addition of element C, element A needs to be modified to be in compliance with the rules, the AI model may generate code to modify element A and generate another test case representing the modified element A. The AI model may then implement the element A test case and scan and analyze the system framework and elements again, with the implemented element A and element B test cases, to determine if further modification is required. In some embodiments, the AI model may repeat this process until the AI model determines that no further modifications are required.

In some embodiments of the disclosure, one or more copies of the system framework may be saved prior to execution of this step of generating and executing test cases to test the generated code. A saved copy may be used as part of an auto-recovery process, as further described below with respect to FIG. 10.

As shown in block 414, the process flow 400 may include the step of determining that the code is ready for implementation. In some embodiments of the disclosure, the AI model determines whether the code is ready for implementation. In some embodiments, determining that the code is ready for implementation is based on executing the test cases. As described above with respect to 412, in some embodiments, the AI model may engage in an iterative process to ensure that all modifications required are captured by the test cases, such that the system framework maintains its functionality. In some embodiments of the disclosure, and as further described below with respect to FIG. 9, determining whether the code is ready for implementation comprises, analyzing the system framework, determining whether the functionality of the elements or dependencies has been negatively impacted by the test cases, determining whether the system framework has been negatively impacted, and determining whether implementation of the code would ensure that the system framework is in compliance with the rules. Upon determining that the functionality of the elements and the dependencies and the system framework have not been negatively impacted and that implementing the code would ensure the system framework is in compliance with the rules, a determination that the code is ready for implementation may be made. In some embodiments, in the iterative process described above with respect to block 412, the AI model, determine whether further modification is required based on the determination of whether the code is ready for implementation. As such, in some embodiments, each of the steps of generating code, generating and executing test cases, and determining whether the code is ready for implementation may occur multiple times and may occur concurrently with the other steps.

In some embodiments of the disclosure, one or more copies of the system framework may be saved prior to execution of this step of determining whether the code is ready for implementation. The saved copy may be used as part of an auto-recovery process, as further described below with respect to FIG. 10.

As shown in block 416, the process flow 400 may include the step of deploying the code upon determining that the code is ready for implementation. In some embodiments, deploying the code comprises modifying the element the code was generated to modify. In some embodiments of the disclosure, deploying the code and modifying the element may comprise adding the generated code to the existing code of the element. In some embodiments, deploying the code and modifying the element may comprise deleting all or a portion of the existing code of the element. In some embodiments, deploying the code and modifying the element may comprise deleting a portion of the existing code of the element and replacing it with the generated code. In some embodiments, deploying the code and modifying the element may comprise any combination of the foregoing.

In some embodiments of the disclosure, one or more copies of the system framework may be saved prior to execution of this step of deploying the code upon determining the code is ready for implementation. The saved copy may be used as part of an auto-recovery process, as further described below with respect to FIG. 10.

FIG. 5 illustrates a process flow 500 for determining, for each element of the system framework, that the element requires modification, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIGS. 1A-1C) may perform the steps of process flow 500. Additionally, and in some embodiments, an AI model (like the AI model shown and described above with respect to FIG. 2) and/or a DLT ledger (like that shown and described above with respect to FIGS. 3A-3B) may perform one or more of the steps of process flow 500.

As shown in block 502, the process flow 500 may include the step of receiving internal rules and external rules. In some embodiments, internal rules may comprise rules and conditions within the system framework that guide the operation of the system framework. For example, rules internal to the system framework may include code that is only executed upon a predetermined action occurring. In some embodiments, internal rules may comprise rules, policies, procedures, and/or the like associated with the entity associated with the system framework. Internal policies that govern how the system framework should function or what it should do, or procedures for how certain issues within the entity should be handled using the system framework, may comprise internal rules of an entity, for example. External rules may comprise those rules external to the system framework or the entity. In some embodiments, for example, external rules may comprise rules applicable to the entity as a whole or rules that apply to a certain type of system framework. In some embodiments, external rules may comprise laws and regulations and may come from regulators, agencies or other governing bodies, as applicable to the system framework or the entity.

In some embodiments, internal rules and external rules may be received from a user associated with the entity. In some embodiments, internal rules and external rules may be received from within the system framework or from a separate system. In some embodiments, internal and external rules may be received from the AI model, which may collect the internal rules and external rules by scanning one or more systems, including the system framework, and reading the data stored in the one or more systems. In some embodiments, the AI model may collect internal or external rules from databases internal or external to the system framework or the entity.

As shown in block 504, the process flow 500 may include the step of analyzing the internal rules, the external rules and the system framework. In some embodiments of the disclosure, the AI model is used to analyze the internal rules, the external rules and the system framework. In some embodiments, the analysis comprises mapping one or more segments of the internal rules or one or more segments of the external rules to each of the one or more elements of the system framework. In some embodiments, the analysis may first comprise identifying the various segments of the internal rules and the external rules. In some embodiments, a segment of the rules may be each individual rule in a set of rules that make up the internal rules or the external rules. In some embodiments, a segment of the rules may comprise a component of an individual rule or the smallest component (e.g., a subsection with no further subsections) of an individual rule. In some embodiments, a segment of the rules may comprise the full set of rules that up the internal rules or the external rules.

In some embodiments of the disclosure, mapping one or more segments of the internal rules or one or more segments of the external rules to each of the one or more elements of the system framework essentially comprises checking each segment of the internal rules and the external rules against each element in the system framework to determine whether the segment of the rule is relevant to the element. For example, a segment of a rule that governs font color may not be relevant to an element that only effects font size. In some embodiments of the disclosure, mapping segments of the rules to the elements may further comprise determining whether any elements may be missing, such that the missing elements would be elements that would be relevant to a segment of the rule. In some embodiments, mapping segments of the rules to the elements may further comprise determining whether there are any elements that, and which elements, are not associated with any relevant rules.

In some embodiments, mapping the segments of the rules to the elements may comprise generating a larger map that connects various segments of the rules and various elements based on how they interact with or depend on one another.

In some embodiments of the disclosure, the AI model may generate insights based on the analysis. In some embodiments the insights may be approved using implemented distributed ledger technology, as further described herein.

As shown in block 506, the process flow 500 may include the step of determining that the system framework requires modification to be in compliance with the internal rules and the external rules. In some embodiments of the disclosure, the AI model determines whether the system framework requires modification to be in compliance with the internal rules and the external rules. In some embodiments, the AI model makes the determination based on the analysis. For example, and in some embodiments, if any element of the system framework requires modification, the AI model may determine requires modification to be in compliance with the internal rules and the external rules. In some embodiments, each individual element may be in compliance with the rules associated with the element, but a combination of elements may need modification for the system framework to be in compliance with the rules. In that case, based on the map of rules to elements, the AI model may determine whether the system framework requires modification considering the entire map and all the elements and how they interact.

As shown in block 508, the process flow 500 may include the step of determining, upon determination that the system framework requires modification, which of the one or more elements of the system framework require modification. In some embodiments of the disclosure, the AI model determines which of the one or more elements of the system framework require modification. In some embodiments, the AI model makes the determination based on the analysis. In some embodiments of the disclosure, an individual element may require modification to comply with the segments of the rule associated with or relevant to that element. In some embodiments, a combination of elements may need to be modified for a component of the system framework, or the system framework as a whole to be in compliance with the internal rules and the external rules. The AI model may analyze the map of the segments of rules associated with the elements, where each level of the system framework would be mapped, to determine which elements in combination would need to be modified for a component of the system framework to be in compliance with the segments of the rules associated with it. In this way, the AI model can determine each of the elements of the system framework that require modification.

FIG. 6 illustrates a process flow 600 for determining one or more modifications for each element of the system framework that needs to be modified, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIGS. 1A-1C) may perform the steps of process flow 600. Additionally, and in some embodiments, an AI model (like the AI model shown and described above with respect to FIG. 2) and/or a DLT ledger (like that shown and described above with respect to FIGS. 3A-3B) may perform one or more of the steps of process flow 600.

As shown in block 602, the process flow 600 may include the step of receiving internal rules and external rules. In some embodiments, internal rules may comprise rules and conditions within the system framework that guide the operation of the system framework. For example, rules internal to the system framework may include code that is only executed upon a predetermined action occurring. In some embodiments, internal rules may comprise rules, policies, procedures, and/or the like associated with the entity associated with the system framework. Internal policies that govern how the system framework should function or what it should do, or procedures for how certain issues within the entity should be handled using the system framework, may comprise internal rules of an entity, for example. External rules may comprise those rules external to the system framework or the entity. In some embodiments, for example, external rules may comprise rules applicable to the entity as a whole or rules that apply to a certain type of system framework. In some embodiments, external rules may comprise laws and regulations and may come from regulators, agencies or other governing bodies, as applicable to the system framework or the entity.

In some embodiments, internal rules and external rules may be received from a user associated with the entity. In some embodiments, internal rules and external rules may be received from within the system framework or from a separate system. In some embodiments, internal and external rules may be received from the AI model, which may collect the internal rules and external rules by scanning one or more systems, including the system framework, and reading the data stored in the one or more systems. In some embodiments, the AI model may collect internal or external rules from databases internal or external to the system framework or the entity.

As shown in block 604, the process flow 600 may include the step of analyzing, using the AI model, the internal rules, the external rules, and the element, wherein the analysis comprises mapping one or more segments of the internal rules or one or more segments of the external rules to the element. In some embodiments of the disclosure, the AI model is used to analyze the internal rules, the external rules and the system framework. In some embodiments, the analysis comprises mapping one or more segments of the internal rules or one or more segments of the external rules to each of the one or more elements of the system framework. In some embodiments, the analysis may first comprise identifying the various segments of the internal rules and the external rules. In some embodiments, a segment of the rules may be each individual rule in a set of rules that make up the internal rules or the external rules. In some embodiments, a segment of the rules may comprise a component of an individual rule or the smallest component (e.g., a subsection with no further subsections) of an individual rule. In some embodiments, a segment of the rules may comprise the full set of rules that up the internal rules or the external rules.

In some embodiments of the disclosure, mapping one or more segments of the internal rules or one or more segments of the external rules to each of the one or more elements of the system framework essentially comprises checking each segment of the internal rules and the external rules against each element in the system framework to determine whether the segment of the rule is relevant to the element. In some embodiments of the disclosure, mapping segments of the rules to the elements may further comprise determining whether any elements may be missing, such that the missing elements would be elements that would be relevant to a segment of the rule. In some embodiments, mapping segments of the rules to the elements may further comprise determining whether there are any elements that, and which elements, are not associated with any relevant rules.

In some embodiments, mapping the segments of the rules to the elements may comprise generating a larger map that connects various segments of the rules and various elements based on how they interact with or depend on one another.

In some embodiments of the disclosure, the AI model may generate insights based on the analysis. In some embodiments the insights may be approved using implemented distributed ledger technology, as further described herein.

As shown in block 606, the process flow 600 may include the step of determining a gap between the element and an associated segment of the internal rules or the external rules. In some embodiments of the disclosure, the AI model may be used to determine a gap between the element and an associated segment of the internal rules or the external rules. In some embodiments, the AI model makes the determination based on the analysis and mapping of the segments of the rules to the elements. In some embodiments, this means that the AI model, for each element, analyzes the element along with each segment of the rules associated with the element and, for each segment of the rule associated with the element, determines the gap between the segment and the element. In some embodiments, there may be no gap between a segment of the rule associated with the element and the element. In some embodiments, a gap may essentially be what is missing in the element that makes the element non-compliant with the segment of the rule. In some embodiments, a gap may be a component of the element that is explicitly opposite to what the segment of the rule requires. In some embodiments, a gap may be any inconsistency between the requirements of the segment of the rule and the element.

As shown in block 608, the process flow 600 may include the step of determining specific modifications to achieve compliance with the internal rules and the external rules. In some embodiments of the disclosure, the AI model determines how the elements need to be modified. In some embodiments, the AI model makes the determination based on based on the gaps identified between the segments of the rules associated with the elements and the elements. For each element, the AI model may analyze gaps between the element and each segment of the rules that is associated with the element. The AI model may then determine whether there are any overlaps in the gaps associated with each element. Based on the analysis, the AI model determines how the element needs to be modified to fill the gaps associated with the element. In some embodiments, a single modification may address multiple gaps associated with the element. In some embodiments, each gap might require a distinct modification. In some embodiments, the AI model may determine whether the element requires additional features to be compliant with the rules or if removing a feature of the element may achieve compliance with the rule. In some embodiments, an element may be modified in one of multiple ways to achieve compliance with the rules. The AI model may determine each of the multiple ways the element may be modified. In some embodiments, determining specific modifications may comprise suggesting specific modifications based on the determination of how the element needs to be modified. In some embodiments of the disclosure, the AI model may suggest specific modifications. In some embodiments, suggesting specific modifications may comprise selecting one of multiple ways in which the element may be modified to comply with the internal and external rules. In some embodiments, determining how the element needs to be modified and suggesting specific modifications may occur simultaneously. In some embodiments, the specific modification may be the same as the determination of how the element needs to be modified. In some embodiments, the specific modification may include additional information. For example, if the AI model determines that the font color needs to be changes, which would be the how an element needs to be modified, suggesting a specific modification may comprise suggesting the font color be changed to black. In some embodiments, the AI model may transmit the suggested specific modification to a user. In some embodiments of the disclosure, the user may approve or reject the suggestion. In some embodiments, the AI model may suggest a different specific modification if the user rejects the one suggested previously. In some embodiments the suggestions may be approved using implemented distributed ledger technology, as further described herein.

FIG. 7 illustrates a process flow 700 for generating code to modify the elements of the system framework that require modification, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIGS. 1A-1C) may perform the steps of process flow 700. Additionally, and in some embodiments, an AI model (like the AI model shown and described above with respect to FIG. 2) and/or a DLT ledger (like that shown and described above with respect to FIGS. 3A-3B) may perform one or more of the steps of process flow 700.

As shown in block 702, the process flow 700 may include the step of generating, using the AI model, multiple code suggestions based on the determination of the one or more modifications for the element. In some embodiments, the AI model is used to generate multiple code suggestions based on the determination of how the element needs to be modified. In some embodiments, the determining how the element needs to be modified and generating multiple code suggestions based on the determination may occur simultaneously. In some embodiments, where there may be multiple ways an element may be modified, the multiple code suggestions may reflect the multiple ways. In some embodiments, if there is only one way that the AI model determines the element needs to be modified, the multiple code suggestions may comprise multiple technical approaches to achieve the same outcome.

As shown in block 704, the process flow 700 may include the step of transmitting the multiple code suggestions to a user device of a user associated with the entity. In some embodiments of the disclosure, the multiple code suggestions are transmitted to the user device of a user in a human-readable form. The user device of the user would display the multiple code suggestions to the user through a display mechanism, such as the screen of the user device. Transmitting the multiple code suggestions in a human-readable form may comprise transmitting the code in a recognizable language, whether a natural language or a computer language, that can be understood by a human without the need for computer processing. In some embodiments, transmitting the multiple code suggestions in a human-readable form may comprise transmitting summaries of the multiple code suggestions. The summaries may provide an overview of what the code would do, how it would function, how it is different from existing code, and/or the like.

As shown in block 706, the process flow 700 may include the step of requesting the user to approve one of the multiple code suggestions. In some embodiments, the user may approve one of the multiple code suggestions through a user interface of the user device to which the multiple code suggestions were transmitted. In some embodiments, the user may reject all of the multiple code suggestions. In that case, the AI model may generate additional code suggestions and transmit the additional code suggestions to the user. The user may approve or reject the additional code suggestions. This process of generating additional code suggestions and transmitting the additional code suggestions to the user for approval may repeat until the user approves any one of the code suggestions. In some embodiments of the disclosure, the user may, through the user interface of the user device, in approving one of the multiple code suggestions, modify the code suggestion.

As shown in block 708, the process flow 700 may include the step of receiving approval from the user for one of the multiple code suggestions. In some embodiments, the system provided for in the disclosure may receive approval from the user via the user device of the user. In some embodiments, the approval may be a binary, true response. In some embodiments, the approval may comprise an instruction from the user. In some embodiments, the approval may comprise the code suggestion with modifications from the user.

As shown in block 710, the process flow 700 may include the step of generating, using the AI model, code based on the approved code suggestion. In some embodiments of the disclosure, the AI model generate computer-readable and implementable code based on the approved code suggestion. Generating code based on the approved suggestion may comprise, in some embodiments and where the code suggestion was human-readable code, generating computer-readable code from the approved suggestion. In some embodiments, generating code based on the approved suggestion, may comprise generating computer-readable code that functions in the way that was summarized as part of the code suggestion transmitted to the user. In some embodiments, generating code comprises incorporating the user's modifications into the code or modifying the suggested code to conform to the user's instructions.

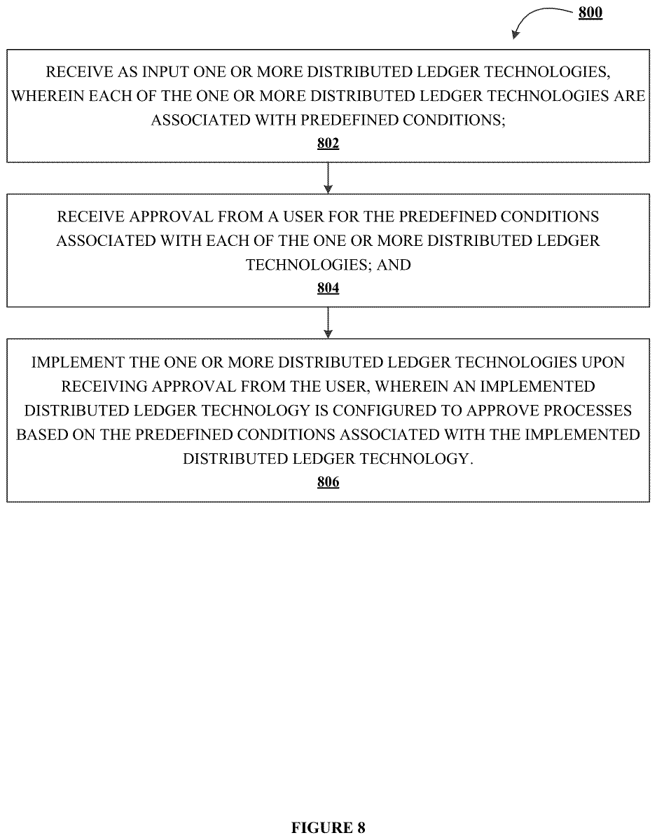

FIG. 8 illustrates a process flow 800 for implementing distributed ledger technologies, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIGS. 1A-1C) may perform the steps of process flow 800. Additionally, and in some embodiments, an AI model (like the AI model shown and described above with respect to FIG. 2) and/or a DLT ledger (like that shown and described above with respect to FIGS. 3A-3B) may perform one or more of the steps of process flow 800.

As shown in block 802, the process flow 800 may include the step of receiving as input one or more distributed ledger technologies, wherein each of the one or more distributed ledger technologies are associated with predefined conditions. In some embodiments, the distributed ledger technologies may be received from a user, from within the system framework, or form an external system. In some embodiments, the user is a user associated with the entity. Predefined conditions may be generated by the user developing the distributed ledger technology. In some embodiments, predefined conditions may comprise some components of the internal or external rules. In some embodiments of the disclosure, predefined conditions are a component of the code that makes up the distributed ledger technologies.

As shown in block 804, the process flow 800 may include the step of receiving approval from a user for the predefined conditions associated with each of the one or more distributed ledger technologies. In some embodiments of the disclosure, a user associated with the entity would approve the predefined conditions associated with each distributed ledger technology. In some embodiments, approval may be received at the same time the distributed ledger technology is received. In some embodiments, approval may be received separate from receiving the distributed ledger technology. In some embodiments, the system may be configured to transmit the distributed ledger technology to a user device of a user to request and receive approval from the user for the predefined conditions associated with the distributed ledger technology.

As shown in block 806, the process flow 800 may include the step of implementing the one or more distributed ledger technologies upon receiving approval from the user. Implementing the one or more distributed ledger technologies may comprise activating the one or more distributed ledger technologies for use to process information. In some embodiments, an implemented distributed ledger technology is configured to approve processes based on the predefined conditions associated with the implemented distributed ledger technology. In some embodiments, essentially, a particular process may be received by the distributed ledger technology and if the process meets each of the predefine conditions associated with the distributed ledger technology, the process is fully processed by the distributed ledger technology and thereby approved.

In some embodiments of the disclosure, various processes performed by the system provided for in the disclosure are approved using distributed ledger technology. In some embodiments, at least one of the following processes performed by the system are approved by using digital ledger technology: analyzing each of the one or more elements and the dependencies to determine functionality and how each of the elements impacts the dependencies of the element; determining, for each of the one or more elements, whether the element requires modification; or determining, for each of the one or more elements that require modification, how the element needs to be modified. In some embodiments of the disclosure, any process performed by the system that comprises making a determination or providing suggestions or insights may be approved using digital ledger technologies.

FIG. 9 illustrates a process flow 900 for determining, based on executing the test cases, whether the code is ready for implementation, in accordance with an embodiment of the disclosure. In some embodiments, a system (e.g., similar to one or more of the systems described herein with respect to FIGS. 1A-1C) may perform one or more of the steps of process flow 900. For example, a system (e.g., the system 130 described herein with respect to FIGS. 1A-1C) may perform the steps of process flow 900. Additionally, and in some embodiments, an AI model (like the AI model shown and described above with respect to FIG. 2) and/or a DLT ledger (like that shown and described above with respect to FIGS. 3A-3B) may perform one or more of the steps of process flow 900.

As shown in block 902, the process flow 900 may include the step of analyzing the system framework. In some embodiments of the disclosure, analyzing the system framework comprises analyzing each of the one or more elements and the dependencies to determine functionality and how each of the elements impacts the dependencies of the elements, as described further with respect to FIG. 4 above. In some embodiments, an AI model is used to analyze the one or more elements and the dependencies. In some embodiments, determining the functionality of an element or a dependency may comprise determining each element's role within the system framework, what the element does, and how important the element is to the functionality of the system framework or another element. For example, and in some embodiments, determining how important the element is may comprise determining whether the system or environment the element is a part of would function without the element. As another example, and in some embodiments, determining how important the element is may comprise determining whether changing element would materially impact the functionality of the dependencies of the element or of a system, environment or system framework as a whole. In some embodiments, determining how each of the elements impacts the dependencies of the element may comprise determining how each the elements and the dependencies interact.

As shown in block 904, the process flow 900 may include the step of determining whether the functionality of the elements and the functionality of the dependencies has been negatively impacted by the test cases. In some embodiments of the disclosure, the AI model is used to determine whether the functionality of the elements and the dependencies has been negatively impacted by the test cases. The AI model may make this determination based on the analyses of the system framework, the one or more elements, and the dependencies. The AI model may determine that the functionality of an element has been negatively impacted if the element does not do what it is intended to do, or a dependency of the element does not function in the manner it was intended to. The AI model may determine that the functionality of a dependency has been negatively impacted if the dependency does not function in the manner it was intended to or if the interaction between the dependency and the element with which the dependency is associated has materially changed, such that other elements are also impacted.

As shown in block 906, the process flow 900 may include the step of determining whether the test cases cause any negative impact to the system framework. In some embodiments of the disclosure, the AI model is used to make the determination. In some embodiments, the AI model makes the determination based on the analysis of the system framework, the elements and the dependencies. The AI model may determine that the system framework has not been negatively impacted if the system framework and every component within the system framework functions as intended. In some embodiments, the AI model may determine if the system framework functions as intended by comparing the results of the analysis to the scan and analysis of the system framework conducted prior to generating any code or test cases. In some embodiments, the AI model may determine that the system framework has been negatively impacted if any of the elements or dependencies within the system framework have been negatively impacted. In some embodiments, the AI model may determine that the system framework has not been negatively impacted even if one or more elements or dependencies have been negatively impacted. In such cases, the AI model may make that determination if the AI model determines that the elements do not significantly affect the functionality of the system framework. For example, if the element that has been negatively impacted has merely an ornamental or tangential impact on the function of the component of the system framework the element falls within, negative impact on that element may not really affect the functioning of the component of the system framework or the system framework as a whole.

As shown in block 908, the process flow 900 may include the step of receiving internal rules and external rules. In some embodiments, internal rules may comprise rules and conditions within the system framework that guide the operation of the system framework. For example, rules internal to the system framework may include code that is only executed upon a predetermined action occurring. In some embodiments, internal rules may comprise rules, policies, procedures, and/or the like associated with the entity associated with the system framework. Internal policies that govern how the system framework should function or what it should do, or procedures for how certain issues within the entity should be handled using the system framework, may comprise internal rules of an entity, for example. External rules may comprise those rules external to the system framework or the entity. In some embodiments, for example, external rules may comprise rules applicable to the entity as a whole or rules that apply to a certain type of system framework. In some embodiments, external rules may comprise laws and regulations and may come from regulators, agencies or other governing bodies, as applicable to the system framework or the entity.

In some embodiments, internal rules and external rules may be received from a user associated with the entity. In some embodiments, internal rules and external rules may be received from within the system framework or from a separate system. In some embodiments, internal and external rules may be received from the AI model, which may collect the internal rules and external rules by scanning one or more systems, including the system framework, and reading the data stored in the one or more systems. In some embodiments, the AI model may collect internal or external rules from databases internal or external to the system framework or the entity.

As shown in block 910, the process flow 900 may include the step of analyzing the internal rules and the external rules. In some embodiments of the disclosure, the AI model is used to analyze the internal rules, the external rules and the system framework. In some embodiments, the analysis comprises mapping one or more segments of the internal rules or one or more segments of the external rules to each of the one or more elements of the system framework. In some embodiments, the analysis may first comprise identifying the various segments of the internal rules and the external rules. In some embodiments, a segment of the rules may be each individual rule in a set of rules that make up the internal rules or the external rules. In some embodiments, a segment of the rules may comprise a component of an individual rule or the smallest component (e.g., a subsection with no further subsections) of an individual rule. In some embodiments, a segment of the rules may comprise the full set of rules that up the internal rules or the external rules.

In some embodiments of the disclosure, mapping one or more segments of the internal rules or one or more segments of the external rules to each of the one or more elements of the system framework essentially comprises checking each segment of the internal rules and the external rules against each element in the system framework to determine whether the segment of the rule is relevant to the element. For example, a segment of a rule that governs font color may not be relevant to an element that only effects font size. In some embodiments of the disclosure, mapping segments of the rules to the elements may further comprise determining whether any elements may be missing, such that the missing elements would be elements that would be relevant to a segment of the rule. In some embodiments, mapping segments of the rules to the elements may further comprise determining whether there are any elements that, and which elements, are not associated with any relevant rules.

In some embodiments, mapping the segments of the rules to the elements may comprise generating a larger map that connects various segments of the rules and various elements based on how they interact with or depend on one another.

As shown in block 912, the process flow 900 may include the step of determining whether implementation of the code would ensure the system framework is in compliance with the internal rules and the external rules. In some embodiments of the disclosure, the AI model is used to determine whether implementation of the code would ensure the system framework is in compliance with the internal rules and the external rules. In some embodiments, the AI model makes the determination based on the analyses of the system framework, the one or more elements, the dependencies, the internal rules, and the external rules. In some embodiments, the analyses are conducted together. The AI model may determine whether implementation of the code would ensure the system framework is in compliance based on the mapping of the segments of the rules to the elements. The AI model may analyze the map at each level to determine compliance at each level of the elements at the level with the associated segments of the rules. In some embodiments of the disclosure, the test cases are executed prior to the analyses, such that the analyses occur as if the code has already been implemented.

As shown in block 916, the process flow 900 may include the step of determining that the code is ready for implementation. In some embodiments, the AI model determines whether the code is ready for implementation. The AI model may make the determination based on the prior determinations made in the process depicted in FIG. 9. In some embodiments, the AI model may determine that the code is ready for implementation if the AI model determined that the functionality of the elements and the functionality of the dependencies has not been negatively impacted by the test cases, that the test cases do not cause any negative impact to the system framework and that implementation of the code would ensure the system framework is in compliance with the internal rules and the external rules. In some embodiments, the AI model may determine that the code is ready for implementation even if one or more elements were negatively impacted, if the elements and the system framework are in compliance with the internal rules and the external rules and if the system framework as a whole has not been materially affected. Essentially, the AI model may determine that minor negative impacts to minor elements that do not have major repercussions are okay. In some embodiments, the AI model may request approval from a user to make such a determination that minor negative impacts to minor elements are okay and that the code is therefore ready for implementation. In some embodiments, and as described further with respect to FIG. 4, if the AI model fails to determine that the implementation of the code would ensure compliance, then various steps in the process depicted in FIG. 4 may be repeated until that determination can be made.

FIG. 10 illustrates a process flow 1000 for implementing an auto-recovery process, in accordance with an embodiment of the disclosure. In some embodiments, a system (e.g., similar to one or more of the systems described herein with respect to FIGS. 1A-1C) may perform one or more of the steps of process flow 1000. For example, a system (e.g., the system 130 described herein with respect to FIGS. 1A-1C) may perform the steps of process flow 1000. Additionally, and in some embodiments, an AI model (like the AI model shown and described above with respect to FIG. 2) and/or a DLT ledger (like that shown and described above with respect to FIGS. 3A-3B) may perform one or more of the steps of process flow 1000.

As shown in block 1002, the process flow 1000 may include the step of saving one or more copies of the system framework. In some embodiments, saving a copy of the system framework may comprise creating a backup of the system framework and storing the backup within the system framework or in an external system. In some embodiments, a copy of the system framework may comprise a copy of only a portion of the system framework. In some embodiments of the disclosure, a copy of the system framework may be automatically saved prior to execution of at least one of the following steps: generating code to modify an element of the system framework; generating and executing test cases to test the code, determining whether the code is ready for implementation, or deploying the code. In some embodiments, a copy of the system framework may be saved upon instruction from a user.

As shown in block 1004, the process flow 1000 may include the step of receiving an instruction from a user associated with the entity to restore a specified copy of the system framework. In some embodiments, the specified copy may be one of the one or more saved copies of the system framework. In some embodiments, the user in the user's instruction would specify which copy needs to be restored. In some embodiments, the saved copies are associated with certain identifiers, such as a name, or the time or date the copy was saved. The user may use the identifiers to identify the specified copy in the user's instruction.

As shown in block 1006, the process flow 1000 may include the step of restore the specified copy of the system framework. In some embodiments of the disclosure, restoring the specified copy of the system framework comprises retrieving a saved copy of the system framework and replacing the current system framework with the saved copy. In some embodiments, where a saved copy is a copy of a portion of the system framework, only that portion may be replaced. In some embodiments, retrieving a saved copy may comprise transmitting a request to the system storing the backup, and receiving from the system the backup in response to the request.

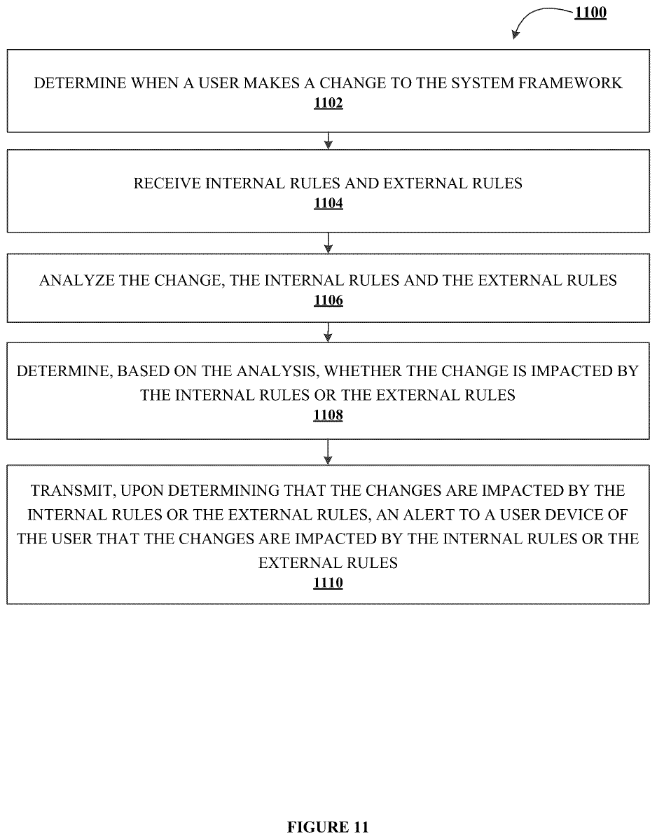

FIG. 11 illustrates a process flow 1100 for alerting a user upon determination that the user made a non-compliance change within the system framework, in accordance with an embodiment of the disclosure. In some embodiments, a system (e.g., similar to one or more of the systems described herein with respect to FIGS. 1A-1C) may perform one or more of the steps of process flow 1100. For example, a system (e.g., the system 130 described herein with respect to FIGS. 1A-1C) may perform the steps of process flow 1100. Additionally, and in some embodiments, an AI model (like the AI model shown and described above with respect to FIG. 2) and/or a DLT ledger (like that shown and described above with respect to FIGS. 3A-3B) may perform one or more of the steps of process flow 1100.

As shown in block 1102, the process flow 1100 may include the step of determining when a user makes a change to the system framework. In some embodiments of the disclosure, the AI model may determine when a user makes a change to the system framework. In some embodiments, the AI model may make the determination based on a continuous scan and analysis of the system framework. If there is a change to the system framework where the change was initiated externally, the AI model may determine that a user made a change. In some embodiments, the user may be a user associated with the entity. In some embodiments, making a change to the system framework may comprise modifying the code that makes up the system framework or any component thereof.

As shown in block 1104, the process flow 1100 may include the step of receiving internal rules and external rules. In some embodiments, internal rules may comprise rules and conditions within the system framework that guide the operation of the system framework. For example, rules internal to the system framework may include code that is only executed upon a predetermined action occurring. In some embodiments, internal rules may comprise rules, policies, procedures, and/or the like associated with the entity associated with the system framework. Internal policies that govern how the system framework should function or what it should do, or procedures for how certain issues within the entity should be handled using the system framework, may comprise internal rules of an entity, for example. External rules may comprise those rules external to the system framework or the entity. In some embodiments, for example, external rules may comprise rules applicable to the entity as a whole or rules that apply to a certain type of system framework. In some embodiments, external rules may comprise laws and regulations and may come from regulators, agencies or other governing bodies, as applicable to the system framework or the entity.

In some embodiments, internal rules and external rules may be received from a user associated with the entity. In some embodiments, internal rules and external rules may be received from within the system framework or from a separate system. In some embodiments, internal and external rules may be received from the AI model, which may collect the internal rules and external rules by scanning one or more systems, including the system framework, and reading the data stored in the one or more systems. In some embodiments, the AI model may collect internal or external rules from databases internal or external to the system framework or the entity.

As shown in block 1106, the process flow 1100 may include the step of analyzing the change, the internal rules and the external rules. In some embodiments of the disclosure, the AI model is used to analyze the internal rules, the external rules and the system framework, wherein the system framework now comprises the change made by the user. In some embodiments, the analysis comprises mapping one or more segments of the internal rules or one or more segments of the external rules to each of the one or more elements of the system framework. In some embodiments, the analysis may first comprise identifying the various segments of the internal rules and the external rules. In some embodiments, a segment of the rules may be each individual rule in a set of rules that make up the internal rules or the external rules. In some embodiments, a segment of the rules may comprise a component of an individual rule or the smallest component (e.g., a subsection with no further subsections) of an individual rule. In some embodiments, a segment of the rules may comprise the full set of rules that up the internal rules or the external rules.

In some embodiments of the disclosure, mapping one or more segments of the internal rules or one or more segments of the external rules to each of the one or more elements of the system framework essentially comprises checking each segment of the internal rules and the external rules against each element in the system framework to determine whether the segment of the rule is relevant to the element. In some embodiments of the disclosure, mapping segments of the rules to the elements may further comprise determining whether any elements may be missing, such that the missing elements would be elements that would be relevant to a segment of the rule. In some embodiments, mapping segments of the rules to the elements may further comprise determining whether there are any elements that, and which elements, are not associated with any relevant rules.

In some embodiments, mapping the segments of the rules to the elements may comprise generating a larger map that connects various segments of the rules and various elements based on how they interact with or depend on one another.

As shown in block 1108, the process flow 1100 may include the step of determining, based on the analysis, whether the change is impacted by the internal rules or the external rules. In some embodiments, the AI model may determine whether the change is impacted by the internal rules or the external rules. In some embodiments, the AI model may make the determination based on the analysis. In some embodiments, the AI model may, upon analysis of the mapping of the segments of the rules to the elements, determine whether any element is inconsistent with the segments of the rules associated with it or otherwise not compliant with the rules associated with it. If the AI model determines that any element is inconsistent with or otherwise not compliant with the rules, the AI model may determine that the change is impacted by the rules.

As shown in block 1110, the process flow 1100 may include the step of transmit an alert to a user device of the user that the changes are impacted by the internal rules or the external rules. The system provided for in the disclosure may alert the user that the change is impacted by the rules upon the determination that the change is impacted by the rules. Alerting the user may comprise generating an alert and transmitting the alert to a user device of the user. In some embodiments the user device may display the alert to the user. In some embodiments, the alert may include text that states that the change is inconsistent with the rules. In some embodiments, where the user made multiple changes, the alert may provide additional information on which specific change is inconsistent with the rules. In some embodiments, if only a portion of the change is inconsistent with the rules, the alert may specify which portion is inconsistent with the rules. In some embodiments, the alert may further comprise insights on how the change is inconsistent with the rules and suggestions on how to fix the change.

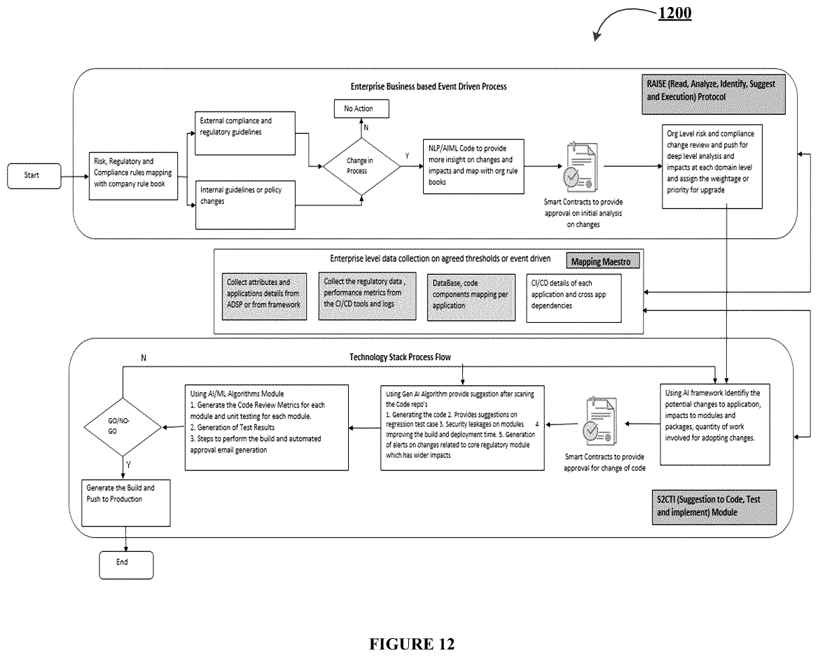

FIG. 12 illustrates a process flow 1200 for analyzing internal and external rules, mapping elements and generating and implementing code, in accordance with an embodiment of the disclosure. In some embodiments, a system (e.g., similar to one or more of the systems described herein with respect to FIGS. 1A-1C) may perform one or more of the steps of process flow 1200. For example, a system (e.g., the system 130 described herein with respect to FIGS. 1A-1C) may perform the steps of process flow 1200. Additionally, and in some embodiments, an AI model (like the AI model shown and described above with respect to FIG. 2) and/or a DLT ledger (like that shown and described above with respect to FIGS. 3A-3B) may perform one or more of the steps of process flow 1200.

In some embodiments of the disclosure, the process flow may start with receiving regulatory or compliance rules that are mapped with the entity's rule book. These rules may essentially comprise external compliance and regulatory guidelines and internal guidelines or policy changes. The next step in the process would be to identify if there has been any change in the rules. This may be determined based on a comparison of the prior versions of external or internal rules received by the system. If there is no change detected, then no action occurs. If a change is detected, natural language processing, machine learning, and artificial intelligence code is used to provide insights on the changes and how the changes impact the existing system processes. A smart contract may be used to approve the initial analysis of the changes, where a smart contract is distributed ledger technology.

After initial approval by the smart contract, the next step may comprise conducting a deeper analysis of how the rules impact each level of the system framework and prioritize the impacts in terms of the need for an upgrade. The deeper analysis may comprise collecting the various attributes of the system framework and all the data associated with the system framework and the rules and mapping the components of each. After the deeper analysis, the artificial intelligence framework, including the natural language processing and the machine learning code, identifies potential changes to the applications in the system framework, impacts of the changes and the difficulty in implementing the change. A smart contract may be used to approve the identified changes. After the smart contract approves the initial identified changes, a generative AI algorithm may be used, after scanning the code repositories of the system framework, to generate code, provide suggestions on test cases, identify security issues, enhance performance, and generate alerts based on changes to the code. The AI framework may be used to generate code and test the code. Upon receiving approval from a user or entity, the code may be pushed to production, such that it is implemented within the system framework.

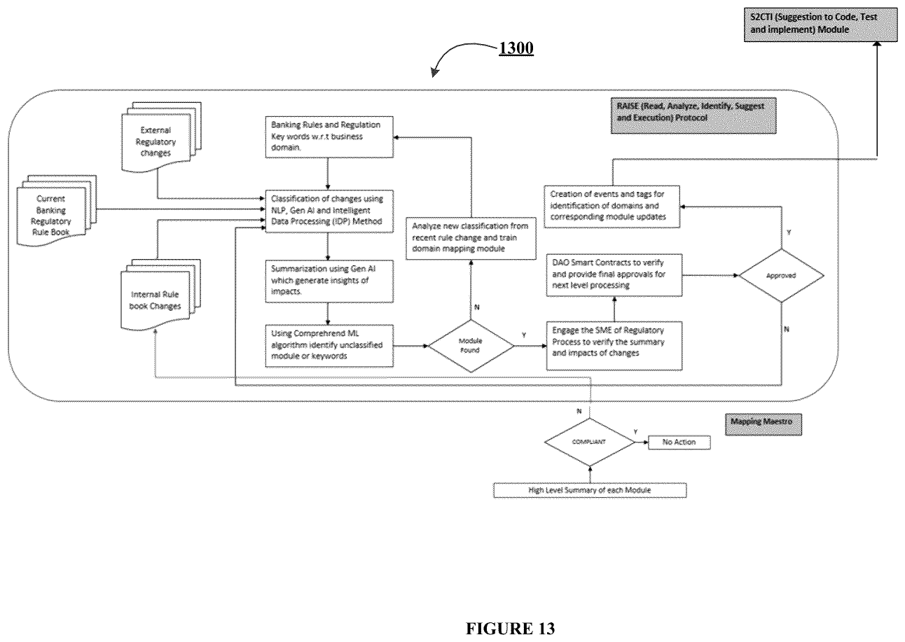

FIG. 13 illustrates a process flow 1300 for analyzing internal and external rules, determining compliance, and generating insights, in accordance with an embodiment of the disclosure, in accordance with an embodiment of the disclosure. In some embodiments, a system (e.g., similar to one or more of the systems described herein with respect to FIGS. 1A-1C) may perform one or more of the steps of process flow 1300. For example, a system (e.g., the system 130 described herein with respect to FIGS. 1A-1C) may perform the steps of process flow 1300. Additionally, and in some embodiments, an AI model (like the AI model shown and described above with respect to FIG. 2) and/or a DLT ledger (like that shown and described above with respect to FIGS. 3A-3B) may perform one or more of the steps of process flow 1300.

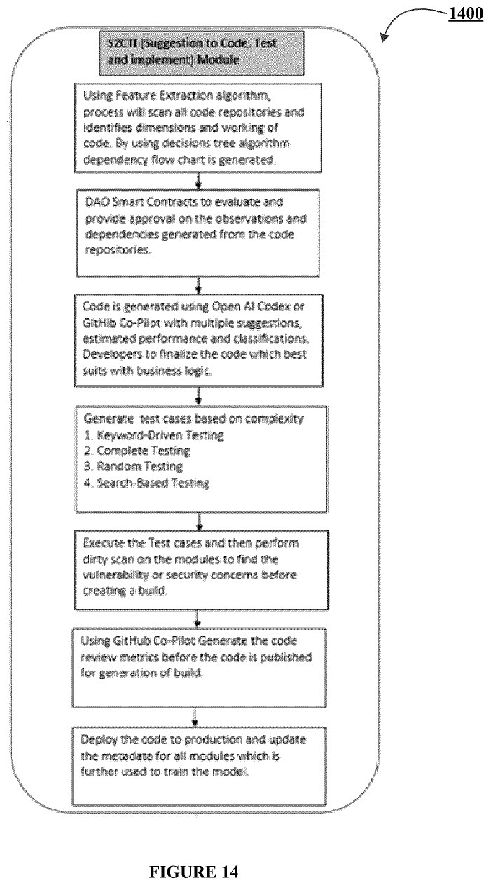

In some embodiments of the disclosure, the process begins with receiving current regulatory rules, and internal and external rule changes. The process further comprises classifying the changes in the rules and modules using natural language processing, generative AI and intelligent data processing methods. The process may further comprise using generative AI to generate insights on the impacts of the changes and modules of the system framework and using machine learning to identify any unclassified modules. If a module is not found, then the process may include analyzing the recent rule changes and training to a domain mapping module for new classifications. If a module is found, then the summary of changes and impacts are verified and approved using smart contracts. If not approved, then the classification and summarization process starts over. If approved, then the process moves on to a module to suggest, test and implement code, as further described with respect to FIG. 14 below.

FIG. 14 illustrates a process flow 1400 for suggesting, generating, testing, and implementing code, in accordance with an embodiment of the disclosure. In some embodiments, a system (e.g., similar to one or more of the systems described herein with respect to FIGS. 1A-1C) may perform one or more of the steps of process flow 1400. For example, a system (e.g., the system 130 described herein with respect to FIGS. 1A-1C) may perform the steps of process flow 1400. Additionally, and in some embodiments, an AI model (like the AI model shown and described above with respect to FIG. 2) and/or a DLT ledger (like that shown and described above with respect to FIGS. 3A-3B) may perform one or more of the steps of process flow 1400.

In some embodiments, suggesting, generating, testing and implementing code occurs as part of an S2CTI module. The module comprises scanning all code repositories and identifying the various aspects of the code and how it works. In some embodiments, the module comprises using a decision tree algorithm to generate a flow chart of dependencies. The module may further comprise using smart contracts to evaluate and provide approval on the observations and dependencies generated from the code repositories. The module may further comprise using generative AI with multiple suggestions, estimated performance and classifications. A developer may finalize the code that best suits the entity's business purposes. The developer may be a user associated with the entity. The module may further comprise generating test cases, executing the test cases and scanning the modules in the system framework to find any vulnerabilities or security issues. The module may further comprise using artificial intelligence to generate the code. The module may further comprise deploying the code and updating the metadata for all modules within the system framework based on the deployed code.

Thus, present embodiments of the disclosure discussed in detail above, the present disclosure provides for process monitoring and optimization using artificial intelligence and distributed ledger technology that allows for the seamless and efficient modification of an entity's system framework. Specifically, the disclosure provides for scanning a system framework to identify the system framework's various elements and the dependencies of those elements and analyzing the elements and the dependencies to determine which elements require modification and how the elements that require modification need to be modified. The disclosure further provides for generating code to modify the elements that need to be modified, testing the code to determine if the code is ready for implementation and, if the code is ready for implementation, deploying the code within the system framework. In some embodiments, an artificial intelligence (AI) model is used for at least one of the processes provided for in the disclosure. In some embodiments of the disclosure, modifications may be required to achieve compliance with internal or external rules. As such, determining whether and how the elements and dependencies need to be modified may comprise receiving and analyzing internal and external rules and analyzing the elements and dependencies along with the internal and external rules to determine gaps between the elements and dependencies and the internal and external rules. In some embodiments, the disclosure provides for continuous, real time monitoring of the system framework and the rules to identify changes to either and determine compliance in real time. In some embodiments of the disclosure, generating code comprises generating multiple code suggestions and receiving approval from a user for one code suggestion to test and deploy. In some embodiments, the disclosure provides for implementing one or more distributed ledger technologies that are used to approve various steps that may occur in the embodiment of the disclosure. In some embodiments, the disclosure provides for implementing an auto-recovery process that saves copies of the system framework at various stages and restores a copy upon receiving an instruction from the user to do so. In some embodiments of the disclosure, the AI model is trained by a user in a first instance and continuously retrained using data associated with each instance the AI model is used.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for process monitoring and optimization using artificial intelligence and distributed ledger technology, the system comprising:
a memory device comprising a non-transitory computer-readable medium with computer-readable program code stored thereon;
at least one processing device operatively coupled to the at least one memory device and at least one communication device, wherein when executed, the computer-readable code is configured to cause the at least one processing device to:
scan a system framework of an entity, wherein scanning the system framework comprises identifying one or more elements of the system framework and dependencies of each of the one or more elements;
analyze each of the one or more elements and the dependencies using an artificial intelligence (AI) model, wherein the analyzing further comprises determining functionality and how each of the elements modifies the dependencies of the element;
determine, using the AI model and for each of the one or more elements, that the element requires modification based on the analysis of the elements and the dependencies;
determine, using the AI model and for each of the one or more elements that require modification, one or more modifications for the element;
generate, using the AI model and for each of the one or more elements that require modification, code to modify the element based on the determination of the one or more modifications for the element;
generate, using the AI model, and execute test cases to test the code, wherein generating and executing test cases comprises implementing the code within one or more isolated portions of the system framework;
determine, using the AI model and based on executing the test cases, that the code is ready for implementation; and
deploy the code upon determining that the code is ready for implementation.

2. The system of claim 1, wherein determining, for each of the one or more elements that require modification, that the element requires modification comprises:
receiving internal rules and external rules;
analyzing, using the AI model, the internal rules, the external rules, and the system framework, wherein the analysis comprises mapping one or more segments of the internal rules or one or more segments of the external rules to each of the one or more elements of the system framework;
determining, using the AI model and based on the analysis, that the system framework requires modification to be in compliance with the internal rules and the external rules; and
determining, using the AI model, based on the analysis and upon determination that the system framework requires modification, which of the one or more elements of the system framework require modification.

3. The system of claim 1, wherein determining, for each of the one or more elements that require modification, one or more modifications for the element comprises:
receiving internal rules and external rules;
analyzing, using the AI model, the internal rules, the external rules, and the element, wherein the analysis comprises mapping one or more segments of the internal rules or one or more segments of the external rules to the element;
determining, using the AI model and based on the analysis, a gap between the element and an associated segment of the internal rules or the external rules; and
determining, using the AI model and based on the gap, specific modifications to achieve compliance with the internal rules and the external rules.

4. The system of claim 1, wherein generating, for each of the one or more elements that require modification, code to modify the element based on the determination of the one or more modifications for the element comprises:
generating, using the AI model, multiple code suggestions based on the determination of how the element needs to be modified;
transmitting, in a human-readable form, the multiple code suggestions to a user device of a user associated with the entity;
requesting the user to approve one of the multiple code suggestions;
receiving approval from the user for one of the multiple code suggestions; and
generating, using the AI model, code based on the approved code suggestion.

5. The system of claim 4, wherein transmitting the multiple code suggestions comprises transmitting summaries of the multiple code suggestions.

6. The system of claim 1, wherein the following steps occur simultaneously and in real time:
scanning the system framework of the entity, wherein scanning the system framework comprises identifying one or more elements of the system framework and dependencies of each of the one or more elements;
analyzing, each of the one or more elements and the dependencies using the AI model, wherein the analyzing further comprises determining functionality and how each of the elements modifies the dependencies of the element; and
determining, using the AI model, for each of the one or more elements, that the element requires modification based on the analysis of the elements and the dependencies.

7. The system of claim 1, the computer-readable code is further configured to cause the at least one processing device to:
receive as input one or more distributed ledger technologies, wherein each of the one or more distributed ledger technologies are associated with predefined conditions;
receive approval from a user for the predefined conditions associated with each of the one or more distributed ledger technologies; and
implement the one or more distributed ledger technologies upon receiving approval from the user, wherein an implemented distributed ledger technology is configured to approve processes based on the predefined conditions associated with the implemented distributed ledger technology.

8. The system of claim 7, wherein the one or more distributed ledger technologies is used to approve at least one of the following processes:
analyzing, each of the one or more elements and the dependencies using the AI model, wherein the analyzing further comprises determining functionality and how each of the elements modifies the dependencies of the element;
determining, using the AI model and for each of the one or more elements, that the element requires modification based on the analysis of the elements and the dependencies; or
determining, using the AI model and for each of the one or more elements that require modification, one or more modifications for the element.

9. The system of claim 1, wherein determining, based on executing the test cases, whether the code is ready for implementation comprises:
analyzing the system framework;
determining, using the AI model and based on the analyses of the system framework, the one or more elements, and the dependencies, that the functionality of the elements and the functionality of the dependencies has not been negatively impacted by the test cases;
determining, using the AI model and based on the analyses, that the test cases do not cause any negative impact to the system framework;
receiving internal rules and external rules;
analyzing the internal rules and the external rules;
determining, using the AI model and based on the analyses of the system framework, the one or more elements, the dependencies, the internal rules, and the external rules, that implementation of the code would ensure the system framework is in compliance with the internal rules and the external rules; and
determining, using the AI model and upon determination that the functionality of the elements and the functionality of the dependencies has not been negatively impacted by the test cases, that the test cases do not cause any negative impact to the system framework and that implementation of the code would ensure the system framework is in compliance with the internal rules and the external rules, that the code is ready for implementation.

10. The system of claim 1, wherein the computer-readable code is further configured to implement an auto-recovery process, wherein the auto-recovery process comprises:
saving one or more copies of the system framework;
receiving an instruction from a user associated with the entity to restore a specified copy of the system framework, wherein the specified copy is one of the one or more copies; and
restoring the specified copy of the system framework.

11. The system of claim 10, wherein the one or more copies of the system framework are saved prior to execution of at least one of the following:
generating, using the AI model and for each of the one or more elements that require modification, code to modify the element based on the determination of how the element needs to be modified;
generating, using the AI model, and execute test cases to test the code, wherein generating and executing test cases comprises implementing the code within one or more isolated portions of the system framework;
determining, using the AI model and based on the test cases, that the code is ready for implementation; or
deploying the code upon determining that the code is ready for implementation.

12. The system of claim 1, wherein the computer-readable code is further configured to:
determine when a user makes a change to the system framework;
receive internal rules and external rules;
analyze the change, the internal rules and the external rules;
determine, based on the analysis, that the changes are impacted by the internal rules or the external rules; and
transmit, upon determining that the change is impacted by the internal rules or the external rules, an alert to a user device of the user that the changes are impacted by the internal rules or the external rules.

13. The system of claim 1, wherein the AI model is trained by a user in a first instance and continuously retrained using data associated with each instance the AI model is used.

14. A computer implemented method for process monitoring and optimization using artificial intelligence and distributed ledger technology, the computer implemented method comprising:
scanning a system framework of an entity, wherein scanning the system framework comprises identifying one or more elements of the system framework and dependencies of each of the one or more elements;
analyzing, each of the one or more elements and the dependencies using an artificial intelligence (AI) model, wherein the analyzing further comprises determining functionality and how each of the elements modifies the dependencies of the element;
determining, using the AI model and for each of the one or more elements, that the element requires modification based on the analysis of the elements and the dependencies;
determining, using the AI model and for each of the one or more elements that require modification, one or more modifications for the element;
generating, using the AI model and for each of the one or more elements that require modification, code to modify the element based on the determination of the one or more modifications for the element;
generating, using the AI model, and execute test cases to test the code, wherein generating and executing test cases comprises implementing the code within one or more isolated portions of the system framework;
determining, using the AI model and based on executing the test cases, that the code is ready for implementation; and
deploying the code upon determining that the code is ready for implementation.

15. The computer implemented method of claim 8, wherein determining, for each of the one or more elements that require modification, that the element requires modification based on the analysis of the elements and the dependencies comprises:
receiving internal rules and external rules;
analyzing, using the AI model, the internal rules, the external rules, and the system framework, wherein the analysis comprises mapping one or more segments of the internal rules or one or more segments of the external rules to each of the one or more elements of the system framework;
determining, using the AI model and based on the analysis, that the system framework requires modification to be in compliance with the internal rules and the external rules; and
determining, using the AI model, based on the analysis and upon determination that the system framework requires modification, which of the one or more elements of the system framework require modification.

16. The computer implemented method of claim 8, wherein the method further comprises:
receiving as input one or more distributed ledger technologies, wherein each of the one or more distributed ledger technologies are associated with predefined conditions;
receiving approval from a user for the predefined conditions associated with each of the one or more distributed ledger technologies; and
implementing the one or more distributed ledger technologies upon receiving approval from the user, wherein an implemented distributed ledger technology is configured to approve processes based on the predefined conditions associated with the implemented distributed ledger technology.

17. The computer implemented method of claim 8, wherein the method further comprises implementing an auto-recovery process, wherein the auto-recovery process comprises:
saving one or more copies of the system framework;
receiving an instruction from a user associated with the entity to restore a specified copy of the system framework, wherein the specified copy is one of the one or more copies; and
restoring the specified copy of the system framework.

18. A computer program product for process monitoring and optimization using artificial intelligence and distributed ledger technology, wherein the computer program product comprises at least one non-transitory computer-readable medium having computer-readable program code portions embodied therein, the computer-readable program code portions which when executed by a processing device are configured to cause the processing device to:
scan a system framework of an entity, wherein scanning the system framework comprises identifying one or more elements of the system framework and dependencies of each of the one or more elements;
analyze, each of the one or more elements and the dependencies using an artificial intelligence (AI) model, wherein the analyzing further comprises determining functionality and how each of the elements modifies the dependencies of the element;
determine, using the AI model and for each of the one or more elements, that the element requires modification based on the analysis of the elements and the dependencies;
determine, using the AI model and for each of the one or more elements that require modification, one or more modifications for the element;
generate, using the AI model and for each of the one or more elements that require modification, code to modify the element based on the determination of the one or more modifications for the element;
generate, using the AI model, and execute test cases to test the code, wherein generating and executing test cases comprises implementing the code within one or more isolated portions of the system framework;
determine, using the AI model and based on executing the test cases, that the code is ready for implementation; and
deploy the code upon determining that the code is ready for implementation.

19. The computer program product of claim 15, wherein determining, for each of the one or more elements that require modification, that the element requires modification based on the analysis of the elements and the dependencies comprises:
receiving internal rules and external rules;
analyzing, using the AI model, the internal rules, the external rules, and the system framework, wherein the analysis comprises mapping one or more segments of the internal rules or one or more segments of the external rules to each of the one or more elements of the system framework;
determining, using the AI model and based on the analysis, that the system framework requires modification to be in compliance with the internal rules and the external rules; and
determining, using the AI model, based on the analysis and upon determination that the system framework requires modification, which of the one or more elements of the system framework require modification.

20. The computer program product of claim 15, wherein the computer-readable program code portions which when executed by a processing device are further configured to cause the processing device to:
receive as input one or more distributed ledger technologies, wherein each of the one or more distributed ledger technologies are associated with predefined conditions;
receive approval from a user for the predefined conditions associated with each of the one or more distributed ledger technologies; and
implement the one or more distributed ledger technologies upon receiving approval from the user, wherein an implemented distributed ledger technology is configured to approve processes based on the predefined conditions associated with the implemented distributed ledger technology.
